(19) United States
(12) Patent Application Publication
(10) Pub. No.: US 2026/0244899 A1
(43) Pub. Date: Aug. 20, 2026

(54) GENERATING DIVERSE AND NOVEL MOLECULAR STRUCTURES USING A GENERATIVE STOCHASTIC NETWORK WITH SYNTHESIS CONSTRAINTS

(71) Applicant: Recursion Pharmaceuticals, Inc., Salt Lake City, UT (US)

(72) Inventors: Emmanuel BENGIO, Montreal (CA); Julien ROY, Montreal (CA); Miruna Teodora CRETU, London (GB)

(21) Appl. No.: 19/539,879

(22) Filed: Feb. 13, 2026

Related U.S. Application Data
(60) Provisional application No. 63/759,676, filed on Feb. 18, 2025.

(51) Int. Cl. G06N 3/045; G06N 3/044; G06N 3/08; G06N 3/084; G06N 3/092

(52) U.S. Cl. CPC G06N 3/045; G06N 3/044; G06N 3/08; G06N 3/084; G06N 3/092

(57) ABSTRACT

The present disclosure relates to systems, non-transitory computer-readable media, and methods that utilize a generative flow network that includes a chemically constrained forward policy network and a chemically constrained backward policy network. Indeed, in one or more implementations, the disclosed systems generate molecular structures from initial viable chemical states by sampling reactants from a chemical-reaction action space. For instance, the disclosed systems train the chemically constrained forward policy network based on reward measures corresponding to molecular structures and by also using generative flow network trajectory balance losses. Moreover, in some instances, the disclosed systems train the chemically constrained backward policy network to select viable backward trajectories corresponding to molecular structures.

### CROSS-REFERENCE TO RELATED APPLICATIONS

This application claims priority to and the benefit of U.S. Provisional Patent Application No. 63/759,676, filed on Feb. 18, 2025, which is incorporated herein by reference in its entirety.

### BACKGROUND

Recent years have seen significant developments in hardware and software platforms for training and utilizing generative methods to explore complex feature spaces. For example, conventional systems train generative methods to sample complex structures such as molecular compounds. Despite these recent advances, conventional systems suffer from a number of technical deficiencies, particularly with regard to accuracy, efficiency, and operational inflexibility in exploring and generating structures in complex feature spaces.

### SUMMARY

Embodiments of the present disclosure provide benefits and/or solve one or more of the foregoing or other problems in the art with systems, non-transitory computer-readable media, and methods for utilizing a generative stochastic network to create novel molecular structures by constraining a forward policy network and reverse policy network to an action space defined by chemical reactions and molecular building blocks through unique training approaches. Specifically, the disclosed systems can train a generative flow network that includes a chemically constrained forward policy network and a chemically constrained backward policy network. For example, to generate biochemical structures, the disclosed systems train the chemically constrained forward policy network based on reward measures corresponding to existing molecular structures and viable chemical reactions and train the chemically constrained backward policy network to select viable backward trajectories that lead to initial viable chemical states.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an overview diagram of a SynFlowNet system generating a molecular structing using a chemically constrained forward policy network and a chemically constrained backward policy network in accordance with one or more embodiments.

FIG. 2 illustrates an example diagram of the SynFlowNet system using the chemically constrained forward policy network to generate molecular structures (with corresponding reward measures) by sampling from a chemical-reaction action space in accordance with one or more embodiments.

FIG. 3A illustrates an example diagram of the SynFlowNet system using a graph transformer to generate various action prediction scores in accordance with one or more embodiments.

FIG. 3B illustrates an example diagram of the SynFlowNet system sampling from molecule generation actions in accordance with one or more embodiments.

FIGS. 4A-4B illustrates example diagrams of the SynFlowNet system using binary Morgan fingerprints to represent molecular building blocks in accordance with one or more embodiments.

FIG. 5 illustrates an example diagram of the SynFlowNet system generating reward measures and modifying parameters of the chemically constrained forward policy network in accordance with one or more embodiments.

FIG. 6 illustrates an example diagram of the SynFlowNet system generating a generative flow network trajectory balance loss in accordance with one or more embodiments.

FIGS. 7A-7B illustrates example diagrams of the SynFlowNet system deconstructing a molecular structure with a series of backward actions in accordance with one or more embodiments.

FIG. 8 illustrates an example diagram of the SynFlowNet system modifying parameters of a chemically constrained backward policy using forward-generated trajectories in accordance with one or more embodiments.

FIG. 9 illustrates an example diagram of the SynFlowNet system modifying parameters of a chemically constrained backward policy using reinforcement learning in accordance with one or more embodiments.

FIG. 10 illustrates experimental results of the estimated size of a state space for the SynFlowNet system compared with additional baselines in accordance with one or more embodiments.

FIGS. 11A-11B illustrates experimental results of comparing the SynFlowNet system using a generative flow network trained on an action space of fragments versus being trained on an action space of synthesis constraints in accordance with one or more embodiments.

FIG. 12 illustrates experimental results of comparing reward and diversity of the SynFlowNet system with soft Q-learning in accordance with one or more embodiments.

FIG. 13 illustrates experimental results of comparing trajectories of the chemically constrained backward policy network trained on maximum likelihood objective, reinforcement learning, and additional baselines in accordance with one or more embodiments.

FIGS. 14A-14B illustrates experimental results of comparing models that use binary Morgan fingerprints versus models that do not use binary Morgan fingerprints in accordance with one or more embodiments.

FIG. 15 illustrates an example environment of the QGFN generation system in accordance with one or more embodiments.

FIG. 16 illustrates an example series of acts to generate a training a chemically constrained forward policy network and training a chemically constrained backward policy network in accordance with one or more embodiments.

FIG. 17 illustrates a block diagram of a computing device for implementing one or more embodiments.

### DETAILED DESCRIPTION

Embodiments of the present disclosure provide benefits and/or solve one or more of the foregoing or other problems in the art with systems, non-transitory computer-readable media, and methods for a SynFlowNet system 100 that generates novel molecular structures utilizing a generative machine learning framework (e.g., to sequentially build novel molecular structures) trained to constrain the feature space to existing chemicals and viable chemical reactions. Unlike existing generative systems (which train models based on sampling from an action space with potentially unrealistic fragments and also contains a very high number of options, relative to the SynFlowNet system 100), the SynFlowNet system 100 utilizes a generative machine learning framework model whose action space is defined by chemical reactions and molecular building blocks to sequentially build new molecules. In particular, the SynFlowNet system 100 samples from a chemical-reaction action space defined by reaction templates (e.g., chemical reactions and existing molecular building blocks), including unimolecular and bimolecular reactions. The SynFlowNet system 100 at each generation step can select from multiple molecule generation actions to synthesize a molecular structure.

In one or more embodiments, the SynFlowNet system 100 incorporates forward synthesis (e.g., a chemically constrained forward policy network) as an explicit constraint of the generative mechanism to bridge the gap between in silico molecular generation (e.g., computer simulated molecule generation) and real-world synthesis capabilities. In doing so, the SynFlowNet system 100 improves the synthesizability of compounds (e.g., molecular structures) and further improves sample diversity (e.g., relative to existing systems). In particular, the SynFlowNet system 100 trains the chemically constrained forward policy network on reward measures and a trajectory balance loss.

Moreover, in one or more embodiments, the SynFlowNet system 100 identifies additional constraints to integrate into a backward generative mechanism (e.g., a chemically constrained backward policy network) to traverse in a backwards directions, which improves exploration and accuracy of the SynFlowNet system 100. In particular, the SynFlowNet system 100 trains parameters of the chemically constrained backward policy network to select viable backward trajectories using a maximum likelihood objective or reinforcement learning.

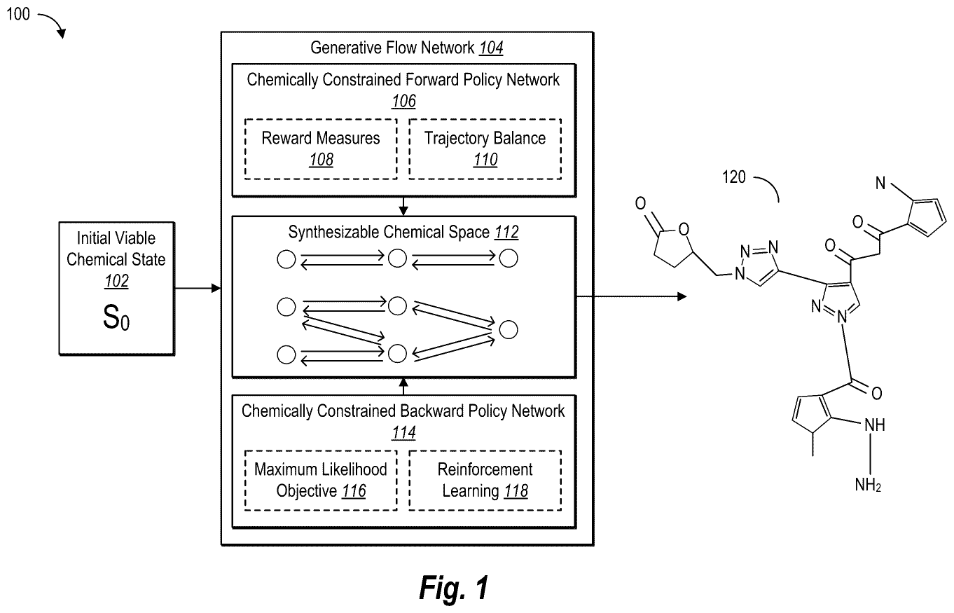

FIG. 1 illustrates the SynFlowNet system 100 generating a molecular structure using a chemically constrained forward policy network and a chemically constrained backward policy network in accordance with one or more embodiments. Specifically, FIG. 1 shows the SynFlowNet system 100 generating a molecular structure 120 from an initial viable chemical state 102.

In one or more embodiments, the SynFlowNet system 100 uses a reaction-based Markov decision process with a generative flow network (GflowNet, also known as a generative stochastic network) to synthesize molecular structures by using a sampling distribution of the learned GflowNet model (e.g., learned through specific training mechanisms such as trajectory balance, maximum likelihood, and reinforcement learning). Specifically, the SynFlowNet system 100 uses a reaction-based Markov decision process with a generative flow network where the objective does not include generating the single highest-return sequence of actions, but rather to maximize both performance and diversity (e.g., by sampling terminal states proportionally to their reward). For instance, the SynFlowNet system 100 demonstrates improved capabilities relative to existing systems, especially in the context of molecule generation (e.g., where the SynFlowNet system 100 explores different modes of the distribution of interest).

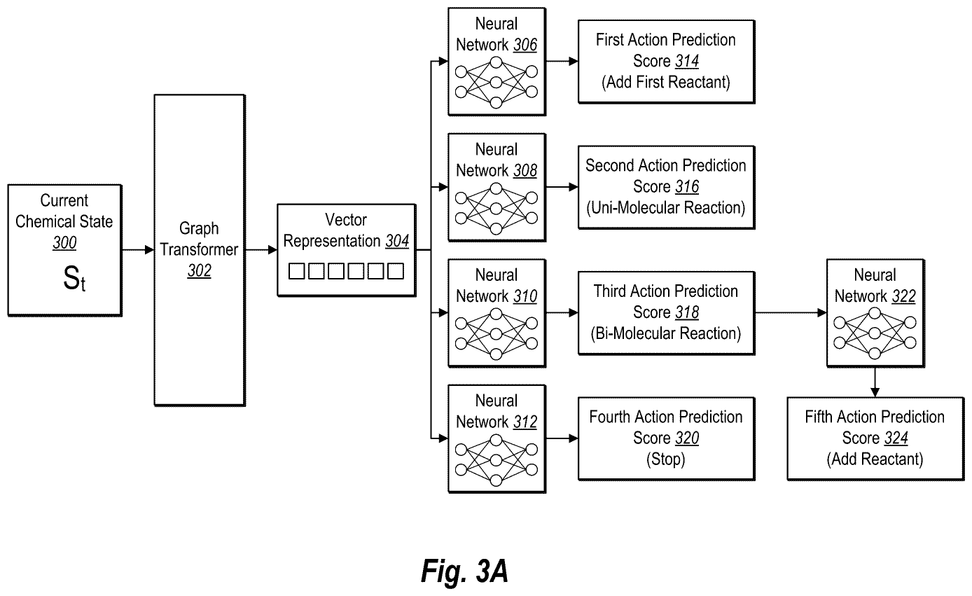

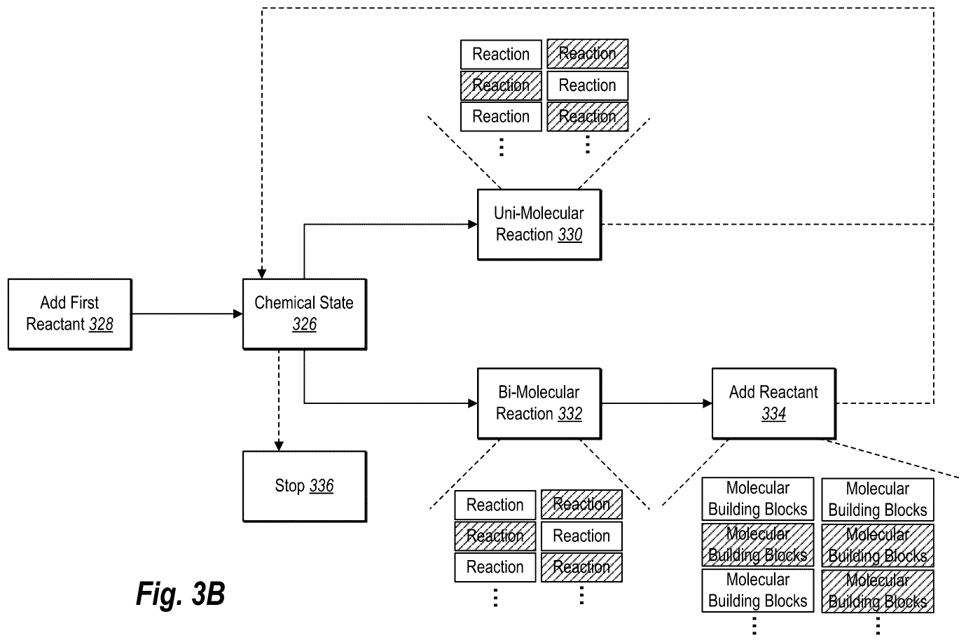

In one or more embodiments, the SynFlowNet system 100 uses a reaction-based Markov decision process generative flow network to synthesize molecular structures. Specifically, a Markov decision process refers to a framework for modeling decision-making. For instance, a Markov decision process is defined by states (e.g., a set of states representing all possible situations in which a decision-making agent can make), actions (e.g., a set of molecule generation actions available to the agent at each state), transition probabilities (the probability of transitioning from state s to state s′ after taking action a), rewards (a reward function that gives the immediate reward received after transitioning from state s to state s′ by taking action a), policy (defines the strategy of the agent), and a discount factor (represents the importance of future rewards). FIGS. 3A-3B provide more details of how the SynFlowNet system 100 trains generative flow networks on a Markov decision process made of molecules obtained from sequences of chemical reactions.

In one or more embodiments, a “generative stochastic model” refers to a probabilistic model that generates synthetic data or structures (e.g., from a learned statistical policy that models an environment based on observed data). Specifically, the SynFlowNet system 100 utilizes the generative stochastic model to analyze an initial input state and further utilizes a stochastic model to estimate a measure of flow that indicates the cumulative probability of reward for downstream paths for a particular option. For instance, the SynFlowNet system 100 can use a generative stochastic model to learn a stochastic policy for generating a final chemical state from a sequence of molecular generation actions, such that the probability of generating a final chemical state is proportional to a reward for that object. The generative stochastic model can utilize a variety of machine learning architectures or approaches. For example, in one or more embodiments, the generative stochastic model can include a GFlowNet, as described in greater detail below.

In some embodiments, the SynFlowNet system 100 utilizes a generative flow network as the generative stochastic model. Specifically, a “generative flow network” refers to a generative framework designed to sample from a chemical-reaction action space, with diversity based on an energy function. Specifically, a generative flow network includes a reinforcement model trained with an objective of sampling a distribution of trajectories whose probability is proportional to a reward. Accordingly, a generative flow network is a machine learning approach that turns a reward into a generative policy that samples with a probability proportional to the return. For instance, a generative flow network applies flow-matching conditions where the flow incoming to a state matches the outgoing flow (proportional to the reward) which leads to learning downstream reward probabilities for any particular option. For example, in some embodiments, the SynFlowNet system 100 utilizes generative flow networks in the manner described in Bengio, E., Jain, M., Korablyov, M., Precup, D., and Bengio, Y., Flow network based generative models for non-iterative diverse candidate generation, Advances in Neural Information Processing Systems, 34:27381-27394, 2021a.; Bengio, Y., Deleu, T., Hu, E. J., Lahlou, S., Tiwari, M., which is fully incorporated by reference herein.

As shown in FIG. 1, the SynFlowNet system 100 processes the initial viable chemical state 102 to generate the molecular structure 120. In one or more embodiments, the SynFlowNet system 100 starts with an empty molecular graph and initializes the initial viable chemical state 102 (e.g., by adding a first reactant, i.e., a molecular building block). For example, the initial viable chemical state 102 refers to an initial or a first molecular building block that is selected from the library of existing molecular building blocks and chemical reactions. Specifically, the initial viable chemical state 102 can include an initial compound (e.g., a molecular building block) that can react (e.g., in response to one or more chemical reactions) to create a subsequent viable chemical state (e.g., an additional chemical state).

For instance, the SynFlowNet system 100 uses the initial viable chemical state 102 such that the sampled molecular building block can react (e.g., in a uni-molecular or bi-molecular reaction) and create a subsequent viable chemical state (e.g., an additional viable chemical state). In other words, the SynFlowNet system 100 does not initiate the initial viable chemical state 102 with a non-viable molecular building block (e.g., the initial viable chemical state contains a molecular building block that can stably maintain its structure, react with another molecular building block, and/or rearrange itself in response to a chemical reaction).

FIG. 1 shows the SynFlowNet system 100 building/synthesizing a molecular graph by utilizing a synthesizable chemical space 112. For instance, the SynFlowNet system 100 uses a chemically constrained forward policy network 106 and a chemically constrained backward policy network 114 of a generative flow network 104 to construct the molecular graph via the synthesizable chemical space 112 (and generate the molecular structure 120).

In one or more embodiments, the chemically constrained forward policy network 106 refers to a generative model that represents distributions over children and parents of flow emanating forward from a specific state. Specifically, the chemically constrained forward policy network 106 refers to a model that samples from the chemical-reaction action space to sequentially build the molecular structure 120. For instance, the SynFlowNet system 100 uses the chemically constrained forward policy network 106 to construct a molecular structure with an associated reward (e.g., a reward based on binding energy of a molecular structure and a particular substrate).

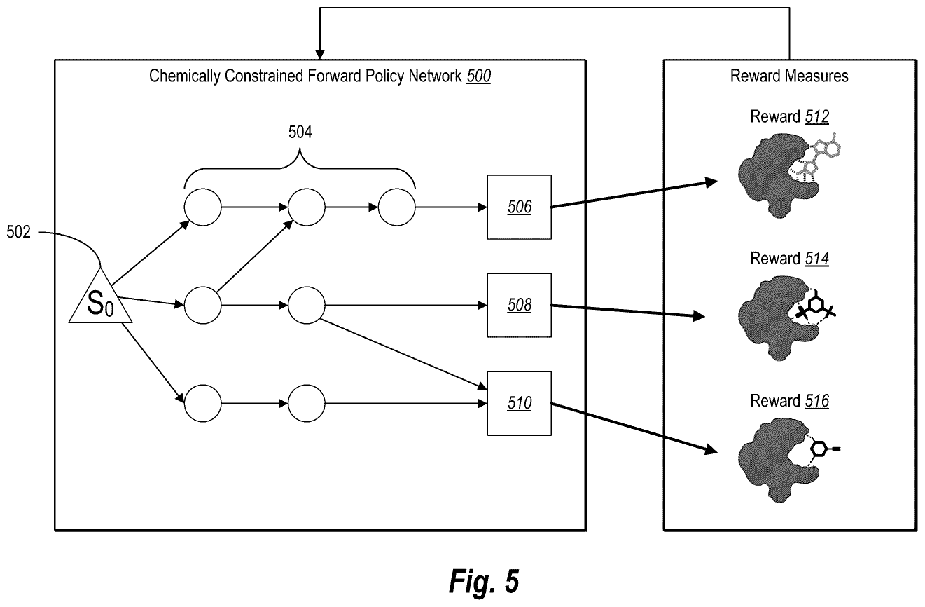

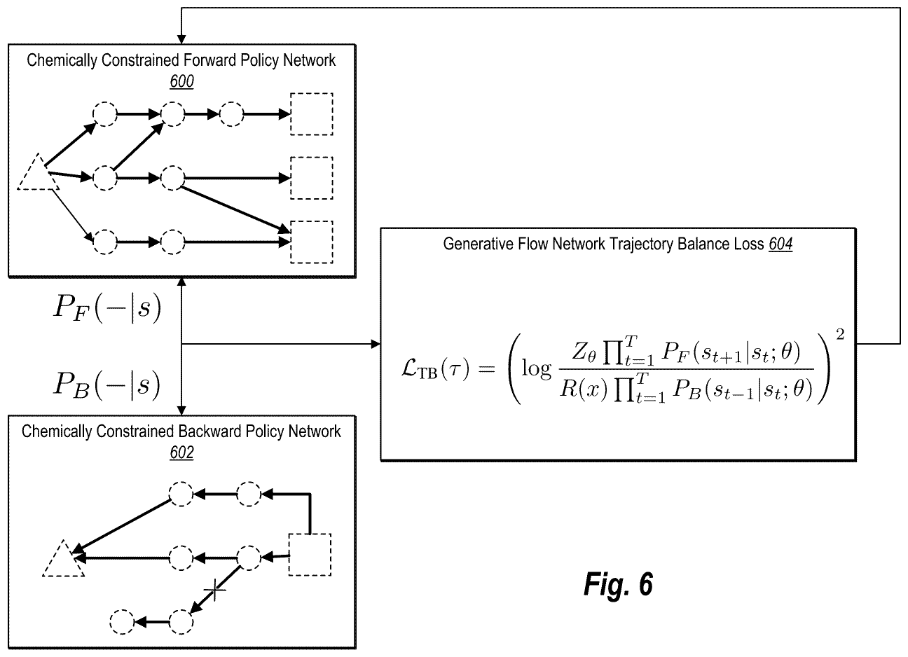

Furthermore, in some embodiments, the SynFlowNet system 100 trains the chemically constrained forward policy network 106 based on reward measures 108 corresponding to the built molecular structures and further trains the network on a generative flow network trajectory balance loss 110 (e.g., a loss that balances a forward policy network and a backward policy network), which is discussed in more detail below in FIGS. 5 and 6. Moreover, at inference time, the SynFlowNet system 100 uses a trained chemically constrained forward policy network to synthesize a novel molecular structure (e.g., a molecular structure with the highest reward) in accordance with one or more objectives (e.g., maximize binding energy).

In one or more embodiments, a chemically constrained backward policy network 114 refers to a generative model that represents distributions over children and parents of flow emanating backward from a molecular structure (e.g., a final viable chemical state). Specifically, the chemically constrained backward policy network 114 refers to a model that samples from the chemical-reaction action space to sequentially deconstruct a molecular structure. For instance, the SynFlowNet system 100 uses the chemically constrained backward policy network 114 to move backwards from the molecular structure 120 to an initial state (e.g., viable or non-viable). Furthermore, as shown in FIG. 1, the SynFlowNet system 100 trains the chemically constrained backward policy network 114 based on maximum-likelihood objective 116 or reinforcement learning 118.

As shown, the SynFlowNet system 100 synthesizes the molecular graph (using the chemically constrained forward policy network 106 and the chemically constrained backward policy network 114) to generate the molecular structure 120. In some embodiments, the SynFlowNet system 100 generates multiple molecular structures and selects one with the highest reward measure (e.g., at training time and at inference time). This is discussed in more detail below.

As shown in FIG. 1, the SynFlowNet system 100 samples/selects the molecular structure 120. In one or more embodiments, the molecular structure 120 refers to an arrangement of molecules and/or atoms. Specifically, the molecular structure 120 refers to a synthesized molecular structure that can include types and quantities of atoms (e.g., carbon, hydrogen, nitrogen, oxygen, etc.), a specific bonding arrangement (e.g., single bonds, double bonds, triple bonds), functional groups (e.g., —OH, —NH2, —COOH, etc.), and a three-dimensional geometry (e.g., a spatial orientation of the molecular structure). Further, the molecular structure 120 includes properties such as topology, folding, and higher-order interactions between structures (e.g., protein complexes, nucleic acid-protein complexes, lipids, etc.).

As mentioned briefly above, conventional systems suffer from a number of technical deficiencies with regard to implementing computing devices. For example, existing systems are inaccurate. For instance, existing systems struggle to design molecules with targeted biochemical properties because existing systems fail to account for synthetic accessibility (e.g., the ease or feasibility of synthesizing a particular molecule, where a lower synthetic accessibility indicates it is easier to synthesize). In other words, existing systems are unrealistic and simulate the generation of molecules that are not synthetically (practically) viable. Specifically, existing systems assemble molecules by composing atoms or molecular fragments into a graph, which can result in sampled molecules that cannot be synthesized (e.g., existing systems sample from potentially unrealistic fragments).

Some existing systems seek to create more realistic molecules by implementing synthetic complexity scores, however, these existing systems rely on heuristics and learned metrics that are oversimplified and fail to accurately account for a variety of complicated factors inherent to molecular synthesis. Moreover, existing systems typically sample from datasets (e.g., that are exponentially growing) and struggle to process these datasets in an accurate manner.

Moreover, in some embodiments, existing systems suffer from an inherent problem of moving in a backward trajectory, the inherent problem being a failure to return back to an initial state (e.g., as traversed by a forward policy network). Accordingly, existing systems suffer from inaccurate backward-constructed trajectories.

Furthermore, in some embodiments, an additional pitfall in relying on datasets that continue to exponentially grow (and contain potentially unrealistic fragments), includes a collapse of space exploration. In other words, existing systems rely on fragment-based creation of molecules and suffer from a lack of sample diversity compared to baselines of existing systems. Specifically, the lack of sample diversity relative to existing basslines results in an inaccurate construction of molecules.

In addition to inaccuracy issues, existing systems further suffer from computational inefficiencies. Specifically, existing systems generate non-viable molecules (e.g., molecules that are unrealistic to synthesize) which results in existing systems having to run further iterations of generating additional molecules. In other words, stemming from the various inaccuracies of existing systems, existing systems suffer from computational inefficiencies of generating and regenerating molecules. Further, existing systems attempt to implement various heuristics to account for inaccuracies, which consumes additional time and computing resources.

Related to the inaccuracy and inefficiency issues, existing systems also suffer from operational inflexibilities. Specifically, existing systems are rigidly limited to generating potentially unrealistic structures and further suffer from working with very large sets of data. For instance, existing systems suffer from operational inflexibility due to the lack of explorative diversity in generating structures.

In one or more embodiments, the SynFlowNet system 100 overcomes the deficiencies of existing systems. For example, in some embodiments, the SynFlowNet system 100 overcomes inaccuracies of existing systems by training and/or utilizing the chemically constrained forward policy network 106 and the chemically constrained backward policy network 114. Specifically, the SynFlowNet system 100 designs molecules with targeted biochemical properties by constraining the sampled action space to existing molecular building blocks and chemical reactions (e.g., reaction templates that are documented chemical reactions and purchasable starting materials). In other words, the SynFlowNet system 100 draws from a synthetically viable action space to design molecules that can realistically be synthesized.

Furthermore, in some embodiments, the SynFlowNet system 100 overcomes issues of existing systems, which implement inaccurate heuristics and learned metrics, by training the chemically constrained forward policy network 106 and the chemically constrained backward policy network 114 in a specially tailored method. For instance, the SynFlowNet system 100 uses reward measures and trajectory balance losses to train the chemically constrained forward policy network 106 and a maximum likelihood objective 116 or reinforcement learning 118 to train parameters of the chemically constrained backward policy network 114.

To rectify issues of existing systems in moving in a backward trajectory (e.g., failing to return back to an initial state traversed by a forward policy network), the SynFlowNet system 100 trains the chemically constrained backward policy network 114 with a separate objective from the chemically constrained forward policy network 106. In doing so, the SynFlowNet system 100 identifies correct backward-generated trajectories and improves sample quality and sample diversity (e.g., in generating molecular structures).

Related to the accuracy improvements, the SynFlowNet system 100 further improves upon computational efficiency by tailoring/optimizing a generative framework to accurately synthesize viable molecules. Thus, the SynFlowNet system 100 avoids running excessive iterations of generating multiple rounds of molecules, which saves time and computing resources. Furthermore, due to the SynFlowNet system 100 being constrained to a chemical-reaction action space, the SynFlowNet system 100 efficiently draws from a reasonably sized dataset (e.g., action space of molecular building blocks and chemical reactions) to synthesize molecular structures. In other words, the SynFlowNet system 100 integrates with target-specific experimental data (e.g., a specific type of objective such as maximizing binding energy of a molecular structure to a binding site) to improve the efficiency of consuming computing resources (in context of a drug discovery pipeline).

Additionally, in some embodiments, the SynFlowNet system 100 improves upon operational flexibility by confining the action space to realistic molecular building blocks and reasonably sized datasets (e.g., relative to conventional systems). In doing so, the SynFlowNet system 100 generates more accurate and diverse molecular structures and improves the flexibility of generating novel molecular structures targeted for drug discovery purposes.

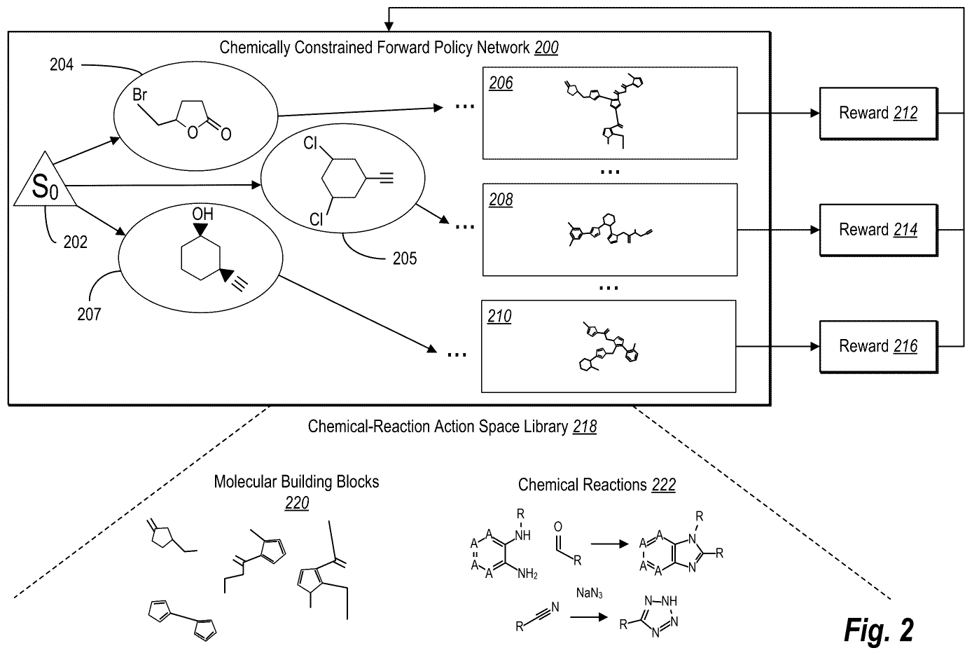

As mentioned above, the SynFlowNet system 100 constricts the action space to a chemical-reaction action space to avoid sampling from unrealistic structures. FIG. 2 illustrates an example diagram of the SynFlowNet system 100 using a chemically constrained forward policy network to generate reward measures corresponding to molecular structures in accordance with one or more embodiments. For example, FIG. 2 shows the SynFlowNet system 100 using a chemically constrained forward policy network 200 which samples from a state space. Specifically, FIG. 2 illustrates the SynFlowNet system 100 using the chemically constrained forward policy network 200 to generate training trajectories by sampling the model forward.

As shown, the SynFlowNet system 100 starts with an initial viable chemical state 202 by initiating an empty molecular graph with a molecular building block. Further, FIG. 2 shows a first subsequent viable chemical state 204 which eventually leads to a first molecular structure 206 (upstream nodes connect to downstream nodes to sequentially build a molecular structure), a second subsequent viable chemical state 205 which eventually leads to a second molecular structure 208, and a third subsequent viable chemical state 207 which eventually leads to a third molecular structure 210.

For instance, the SynFlowNet system 100 utilizes the chemically constrained forward policy network 200 to induce a state space by combining molecular building blocks 220 (e.g., purchasable building blocks) and chemical reactions 222 from a chemical-reaction action space. Specifically, in some embodiments, the SynFlowNet system 100 draws from a chemical-reaction action space library 218.

In one or more embodiments, the chemical-reaction action space refers to an action space defined by the chemical reactions 222 and the molecular building blocks 220 (e.g., reactants) to sequentially build novel molecules (e.g., novel molecular structures). For example, the chemical-reaction action space refers to an explicit constraint of a generative mechanism that is constrained to sample from a library of existing/buyable reactants (e.g., the molecular building blocks 220) and corresponding reaction templates (e.g., the chemical reactions 222). As mentioned above, the SynFlowNet system 100 restrains the chemically constrained forward policy network 200 to the chemical-reaction action space to bridge a gap between in silico molecular generation (e.g., computational techniques to design molecular structures) and real-world molecular synthesis capabilities (e.g., to synthesize realistic and novel molecular structures).

As also mentioned above, in some embodiments, the SynFlowNet system 100 samples from the chemical-reaction action space by sampling from a library of existing molecular building blocks and chemical reactions. Specifically, the chemical-reaction action space library 218 refers to a host of chemical compounds and reagents that serve as starting materials for synthesizing more complex molecular structures (e.g., synthesis for drug discovery). For instance, the chemical-reaction action space library 218 can include chemically diverse compounds that include rare or unique functional groups. In other words, the library contains molecular building blocks and reaction templates that indicate which compounds certain molecular building blocks can react with.

As already mentioned, the chemical-reaction action space library 218 contains the molecular building blocks 220 and the chemical reactions 222. In one or more embodiments, a molecular building block refers to a diverse structural molecule (e.g., structurally the molecular building block can come as an aromatic ring, a heterocycle, an aliphatic chain, etc.) that serves as a foundational unit for constructing a molecular structure (e.g., a complex chemical compound). For instance, a molecular building block includes one or more reactive functional groups (e.g., amine, carboxylic acid, halogen) that can react with other molecular building blocks (e.g., react according to a reaction template). In one or more embodiments, the molecular building blocks 220 are existing molecular building blocks that are well established in the scientific literature (e.g., which contributes to synthesizing realistic and novel molecular structures).

In one or more embodiments, the chemical reactions 222 refer to predefined chemical reactions that define how specific molecular building blocks can be combined with other molecules to synthesize more complex molecular structures and/or how a specific molecular building block can be rearranged/reconfigured. For instance, the chemical reactions 222 include an indication of the necessary reactants (e.g., the molecular building blocks 220) catalysts, solvents, and conditions to successfully synthesize a more complex molecular structure from a current molecular/chemical state. Specifically, the chemical reactions 222 include an encoding of real reactions that occur between reactants in experimental laboratories.

To illustrate, the SynFlowNet system 100 encodes the chemical reactions 222 using chemical regular expressions (e.g., expressions that indicate reaction patterns, chemical structures, and/or functional groups), which allows for an efficient way to search for chemical patterns that can aid the SynFlowNet system 100 in sampling a molecular building block. In particular, the SynFlowNet system 100 can search a library of molecular building blocks to narrow down a set of molecular building blocks to building blocks that have a substructure match (e.g., based on the chemical regular expressions) to a current chemical state. For instance, in some embodiments, the SynFlowNet system 100 encodes the chemical reactions (reaction templates) from publicly available datasets.

In one or more embodiments, the SynFlowNet system 100 uses the chemically constrained forward policy network 200 to sample from a library containing commercially available building blocks (e.g., which are fragments of molecules prepared in bulk to be readily synthesized into candidate molecules). Furthermore, the SynFlowNet system 100 utilizes the chemically constrained forward policy network 200 to sample from chemical reactions (reaction templates) that are obtained from publicly available template libraries. For instance, the publicly available template libraries are described in Alexander Button, Daniel Merk, Jan A Hiss, and Schneider Gisbert, Automated de novo molecular design by machine intelligence and rule-driven chemical synthesis, Nature Machine Intelligence, 1(7):307-315, 2019, and Walter M Rupp, M Reisen, F. Proschak, E. Weggen, S. Stark. H. schneider, G. Hartenfeller M., Zettle H., DOGS: reaction-driven de novo design of bioactive, PLOS Computational Biology, 8(2), 2012, doi: 10.1371/journal.pcbi.1002380. To illustrate, the SynFlowNet system 100 can preprocess the publicly available template libraries to obtain a total of 105 reaction templates (e.g., that indicate how specific molecular building blocks can be combined with other molecules), which include 13 uni-molecular reactions and 92 bi-molecular reactions.

In one or more embodiments, the SynFlowNet system 100 uses the chemically constrained forward policy network 200 to sample from a library of Enamine REAL (readily accessible) reactions. Specifically, the SynFlowNet system 100 specializes the chemically constrained forward policy network 200 with a particular target (e.g., binding energy of a molecule to a protein) and performs a fragment screen with x-ray crystallography to generate experimentally validated fragments (e.g., for the chemically constrained forward policy network 200 to sample from).

In one or more embodiments, the SynFlowNet system 100 samples from the Enamine REAL library to select a set of building blocks to compare with the experimentally validated fragments to identify target specific building blocks. Specifically, the SynFlowNet system 100 uses set of building blocks to synthesize (novel) molecules that can be compared to the experimentally validated fragments. In other words, the SynFlowNet system 100 curates the building block set within a library and the library is adapted based on experimentally validated fragments for a given objective (e.g., a target such as maximizing binding energy). In one or more embodiments, the SynFlowNet system 100 utilizes the curated library which improves reward seeking actions over sampling from random molecular building blocks.

In one or more embodiments, the SynFlowNet system 100 uses fragment-based drug discovery to increase the efficiency of drug discovery processes. For instance, rather than screening a large chemical space, the SynFlowNet system 100 samples from a relatively low number of small compounds, which are screened and experimentally validated. Specifically, the SynFlowNet system 100 uses the screened and validated building blocks to synthesize full molecular structures (e.g., synthesized in a in silico manner).

For instance, the SynFlowNet system 100 leverages experimental data from x-ray fragment screens to guide and enhance the capabilities of the chemically constrained forward policy network 200. Specifically, as mentioned above, the SynFlowNet system 100 compiles building block sets with high similarity to fragments confirmed by x-ray crystallography which biases the library towards fragments with known protein-ligand complementarity and increases the reward over randomly selected molecules during the synthesis of molecular structures.

As shown in FIG. 2, the SynFlowNet system 100 generates a first reward measure 212 for the first molecular structure 206, a second reward measure 214 for a second molecular structure 208, and a third reward measure 216 for a third molecular structure 210. As further shown, based on the reward measures, the SynFlowNet system 100 modifies parameters of the chemically constrained forward policy network 200, which is discussed in more detail below in the description of FIG. 5.

As mentioned above, the SynFlowNet system 100 trains generative flow networks on a Markov decision process made of molecules obtained from sequences of molecule generation actions. FIG. 3A illustrates an example diagram of the SynFlowNet system 100 using a graph transformer to generate action prediction scores for a plurality of molecule generation actions. As mentioned above, the SynFlowNet system 100 trains generative flow networks on a Markov decision process. For instance, to model synthetic pathways as trajectories in a generative flow network, the SynFlowNet system 100 starts from purchasable compounds and ends with molecules that are optimized for some desired properties, via a set of permissible reaction templates (e.g., chemical reactions). At each timestep t, the state sₜ represents a current chemical state 300 (e.g., an initial viable chemical state) and stepping forward in the environment includes building up the current chemical state 300 by applying new reactions and/or reactants until either a termination action is chosen, or the path reaches a maximum length (e.g., as established by the SynFlowNet system 100).

FIG. 3A illustrates the SynFlowNet system 100 using the Markov decision making process for a single timestep. The chemically constrained forward policy network (P_{F} (a|s)) is parameterized as a graph transformer 302 which at each timestep (each viable chemical state) processes the current chemical state 300 and outputs a vector representation 304.

In one or more embodiments, the graph transformer 302 refers to a neural network model to process and analyze data from a generative flow network. Specifically, the graph transformer 302 processes and analyzes data from the chemically constrained forward policy network and the chemically constrained backward policy network. For instance, the SynFlowNet system 100 treats each viable chemical state of the forward and backward policy network as nodes of a graph and the nodes are further connected by edges (e.g., indicating the flow from one state to another state). Moreover, the SynFlowNet system 100 uses the graph transformer 302 to generate the vector representation 304 of the current chemical state 300 (e.g., or an additional chemical state).

In one or more embodiments, the vector representation 304 refers to a mathematical representation of an object (e.g., a chemical state) in a high-dimensional space. Specifically, the vector representation 304 captures the biochemical data from a chemical state such as molecular building block(s) at the chemical state and/or a number of synthesis steps up to the current chemical state. Moreover, as shown, the SynFlowNet system 100 uses the vector representation 304 as a shared embedding which is passed to separate neural networks. As shown in FIG. 3A, the SynFlowNet system 100 passes the vector representation 304 to a neural networks 306-312 (e.g., and also to neural network 322).

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

In one or more embodiments, the SynFlowNet system 100 utilizes a multi-layer perceptron as the neural network. For example, a multi-layer perceptron refers to an artificial neural network with multiple layers of neurons that are fully connected. Specifically, a multi-layer perceptron includes an input layer, where the input data is fed into the network, hidden layers (e.g., intermediate layers between an input and output layer, where the hidden layers receive input from all the neurons in the previous layer), and an output layer that generates a multi-layer perceptron output.

In one or more embodiments, the SynFlowNet system 100 utilizes a plurality of neural networks to generate action prediction scores for molecule generation actions from the vector representation 304. Specifically, the action prediction scores refer to a raw unnormalized probability score for selecting a specific action in a decision-making task. For instance, the SynFlowNet system 100 generates action prediction scores for forward actions (e.g., actions in the chemically constrained forward policy network) that include add first reactant, uni-molecular reaction, bi-molecular reaction (e.g., for bi-molecular reaction, the SynFlowNet system 100 further generates an action prediction score for an add reactant action), and a stop action.

As shown in FIG. 3A, the SynFlowNet system 100 utilizes the neural network 306 to generate a first action prediction score 314 (e.g., corresponding to add first reactant), the neural network 308 to generate a second action prediction score 316 (e.g., corresponding to uni-molecular reaction), the neural network 310 to generate a third action prediction score 318 (e.g., corresponding to bi-molecular reaction), and the neural network 312 to generate a fourth action prediction score 320 (e.g., corresponding to a stop action). Further, in some embodiments, the SynFlowNet system 100 utilizes the neural network 322 to generate a fifth action prediction score 324 (e.g., corresponding to add reactant).

In one or more embodiments, the SynFlowNet system 100 utilizes the chemically constrained forward policy network to move from an empty molecular graph to an initial viable chemical state. For instance, the SynFlowNet system 100 performs an add first reactant action to move from the empty molecular graph to the initial viable chemical state. For subsequent actions downstream from the initial viable chemical state, the SynFlowNet system 100 selects from the uni-molecular reaction, the bi-molecular reaction (e.g., also the add reactant action), and the stop action. To illustrate, the action prediction scores are action logits (e.g., raw unnormalized scores that are passed to a softmax layer) for the different molecule generation actions (e.g., the forward actions).

As mentioned above, the action prediction scores correspond to molecular generation actions. For example, the molecule generation actions refer to acts that build a molecular structure (e.g., from an initial viable chemical state). Specifically, the molecule generation actions of add first reactant and add reactant contains a set of molecular building blocks and chemical reactions (e.g., sampled from the chemical-reaction action space library). In other words, the molecule generation actions act as broad types of umbrella categories for the molecular building blocks and the chemical reactions in the chemical-reaction action space. Thus, the SynFlowNet system 100 generates action prediction scores for each of the types of molecule generation actions. Furthermore, at each of the molecule generation steps (where a molecular building block is sampled), the SynFlowNet system 100 selects from molecular building blocks with reaction templates that indicate reactions and/or molecular building blocks for a given chemical state.

As mentioned above, the first action prediction score 314 corresponds to the action add first reactant. In one or more embodiments, the SynFlowNet system 100 utilizes the chemically constrained forward policy network to start with an empty molecular graph which is followed by a building block sampled from the molecule generation action of add first reactant (AddFirstReactant). In other words, with an empty molecular graph, the SynFlowNet system 100 generates an action prediction score for add first reactant higher than the other action prediction scores, such that the SynFlowNet system 100 selects a first molecular building block to initiate the molecular graph.

As also mentioned, the second action prediction score 316 corresponds to a uni-molecular reaction. In one or more embodiments, a uni-molecular reaction action refers to a chemical reaction where a single molecular structure (e.g., the current molecular state 300) undergoes a transformation to produce a product.

To illustrate, the uni-molecular reaction involves a rearrangement, decomposition, or another transformation such as breaking bonds, changing an electron distribution, and rearranging bonds. For instance, a uni-molecular reaction includes isomerization (changing structure without breaking any bonds, e.g., forming an isomer), decomposition (breaking down the molecular building block into smaller components or atoms), dissociation (splitting the molecular building block into two or more products, e.g., from increasing the overall energy), and activation (e.g., a reaction that involves spontaneous activation energy through heat or light).

As mentioned, the third action prediction score 318 corresponds to a bi-molecular reaction. In one or more embodiments, a bi-molecular reaction refers to a chemical reaction where two reactant molecules (e.g., the current chemical state 300 and an additional reactant) interact to generate a product. To illustrate, a bi-molecular reaction depends on a collision between the current chemical state and an additional reactant molecule (with the proper orientation, correct level of energy, etc.).

As mentioned, the fifth action prediction score 324 corresponds to add reactant, which is an available molecule generation action if the bi-molecular reaction is sampled. In one or more embodiments, add reactant refers to the SynFlowNet system 100 determining to sample the bi-molecular reaction and then further sampling the reactant to add to the current chemical state to perform the bi-molecular reaction. As shown, the SynFlowNet system 100 further utilizes a neural network (a multi-layer perceptron) to generate an action prediction score for add reactant.

As mentioned, the fourth action prediction score 320 corresponds to a stop action. In one or more embodiments, a stop action refers to the SynFlowNet system 100 determining to terminate the sequential building of a molecular structure. Specifically, the SynFlowNet system 100 determines that no additional molecular building blocks need to be added (e.g., there are no further molecular building blocks that viably react with the current chemical state 300). Thus, when the SynFlowNet system 100 determines to sample the stop action, the SynFlowNet system 100 uses the molecular building block(s) at the current chemical state 300 as the molecular structure.

FIG. 3B illustrates an example diagram of the SynFlowNet system 100 sampling from molecule generation actions at each timestep of a Markov decision process and masking certain molecular building blocks in accordance with one or more embodiments. As shown, FIG. 3B illustrates the SynFlowNet system 100 selecting the molecule generation action of add first reactant 328 to sample a molecular building block from a plurality of molecular building blocks. Specifically, for the add first reactant 328 step, the SynFlowNet system 100 samples from one of the molecular building blocks available for the add first reactant 328 action. In this manner, the SynFlowNet system 100 selects an initial viable chemical state (e.g., the chemical state 326) for building a molecular structure. As shown, after performing the add first reactant 328 action, the SynFlowNet system 100 is in the chemical state 326.

As shown, the SynFlowNet system 100 proceeds from the chemical state 326 by sampling a molecule generation action (e.g., selecting between a uni-molecular reaction 330 and a bi-molecular reaction 332). In one or more embodiments, prior to sampling molecule generation actions in the forward direction, the SynFlowNet system 100 ensures that molecular building blocks to be sampled are compatible with the current chemical state. Specifically, the SynFlowNet system 100 masks molecular building blocks that are incompatible with a current chemical state, as indicated by a corresponding reaction template (e.g., chemical reaction).

For instance, the SynFlowNet system 100 masks one or more reactions and/or molecular building blocks (e.g., masks a subset of reactions and/or molecular building blocks) based on molecular-reaction incompatibilities. In other words, the SynFlowNet system 100 ensures that the reactions and/or molecular building blocks to be sampled are compatible with the current state (e.g., the chemical state 326). For instance, the SynFlowNet system 100 checks for substructure matches between potential molecular building blocks and the chemical state 326. To illustrate, the chemical reactions (reaction templates) indicate incompatibilities based on experimental data and existing scientific literature (e.g., reaction templates indicate that certain molecular building blocks would not viably interact with a current chemical state).

As shown, in response to determining molecular-reaction incompatibilities, the SynFlowNet system 100 masks (e.g., as indicated by the stripped lines) one or more reactions and/or molecular building blocks corresponding to certain chemical reactions (e.g., reaction templates). Specifically, FIG. 3B shows that for the uni-molecular reaction 330, the bio-molecular reaction 332, and/or the add reactant 334, the SynFlowNet system 100 masks a subset of reactions and/or molecular building blocks.

For instance, FIG. 3B shows that for the uni-molecular reaction, the SynFlowNet system 100 masks one or more reactions based on the chemical state 326, masks one or more reactions for the bi-molecular reaction 332 based on the chemical state 326, and masks one or more molecular building blocks for the add reactant 334 action based on the chemical state 326. Moreover, FIG. 3B shows that for the add first reactant 328 action, the SynFlowNet system 100 does not perform masking because the SynFlowNet system 100 has a blank slate to select a molecular building block.

Indeed, as shown in FIG. 3B, the SynFlowNet system 100 selects from additional molecule generation actions to continue building the first trajectory. As shown, the SynFlowNet system 100 can select from a molecule generation action of uni-molecular reaction 330 or a bi-molecular reaction 332. FIG. 3B shows that the uni-molecular reaction 330 involves the chemical state 326 transforming to a new chemical state. Moreover, FIG. 3B shows that the bi-molecular reaction 332 involves the chemical state 326 reacting with the chemical state 326 and a molecular building block.

In one or more embodiments, if the SynFlowNet system 100 selects a bi-molecular reaction, then the SynFlowNet system 100 uses the chemical state 326 as an additional input to the additional multi-layer perceptron (e.g., the neural network 322) along with the state embedding (e.g., the vector representation 304) to sample a subsequent action of type add reactant. Specifically, the SynFlowNet system 100 feeds the chemical state 326 and the vector representation into the additional multi-layer perceptron to generate raw scores (action logits) for all the molecular building blocks associated with add reactants.

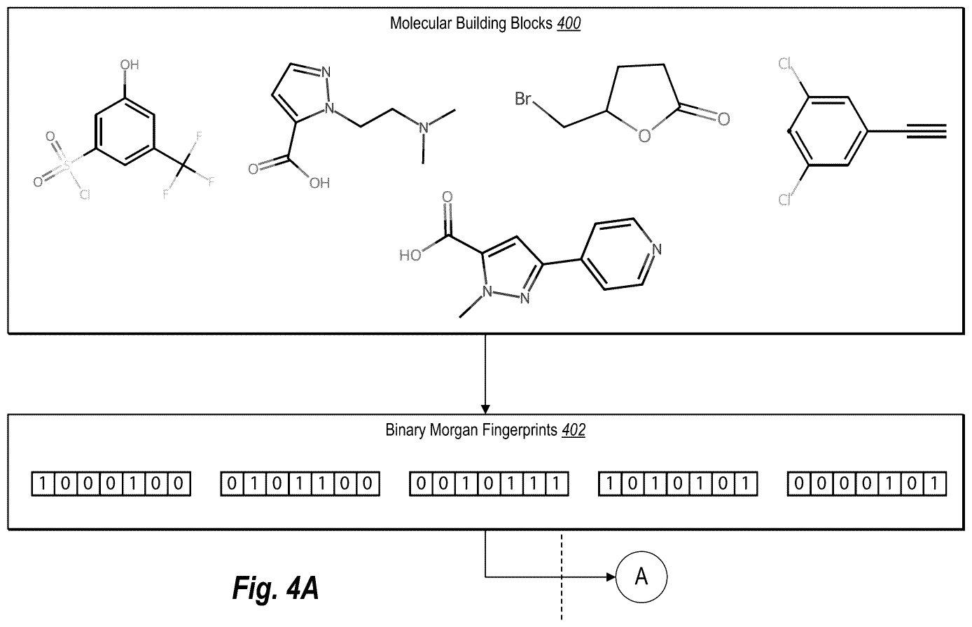

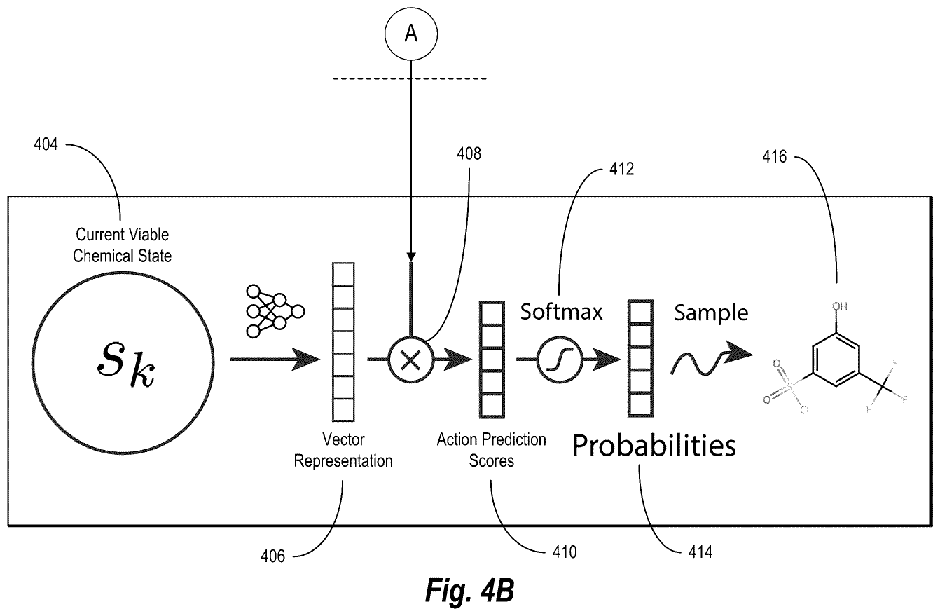

For instance, FIG. 3B shows for add reactant 334, a plurality of molecular building blocks, where a subset of the molecular building blocks is masked based on the corresponding chemical reactions indicating whether the molecular building blocks can viably react with the chemical state 326. The specific mechanism/details of selecting a molecular building block from the add reactants is described below in FIGS. 4A-4B.

Moreover, FIG. 3B shows that at the chemical state 326, the SynFlowNet system 100 can further determine to sample a stop action 336. As mentioned above, the SynFlowNet system 100 generates an action prediction score for the stop action 336 which indicates whether the SynFlowNet system 100 should use the chemical state 326 as the molecular structure.

In some embodiments, the SynFlowNet system 100 generates action prediction scores for each of the molecule generation actions (e.g., add first reactant, stop, uni-molecular reaction, bi-molecular reaction, add reactant) and after determining to sample one of the molecule generation actions, the SynFlowNet system 100 further generates action prediction scores for all of the molecular building blocks and/or chemical reactions associated with the sampled molecule generation action (e.g., if uni-molecular reaction, bi-molecular reaction, or add reactant is sampled). In some embodiments, the SynFlowNet system 100 generates action prediction scores for all molecular building blocks and/or chemical reactions associated with each of the relevant molecule generation actions and selects the molecular building block and/or chemical reaction with the highest action prediction score. In other words, in some embodiments, the SynFlowNet system 100 generates action prediction scores for molecular building blocks and/or chemical reactions associated with the molecule generation actions in parallel with generating action prediction scores for the molecule generation actions.

Furthermore, FIG. 3B further indicates dotted arrows from the uni-molecular reaction 330 and the add reactant 334. Specifically, FIG. 3B shows that the synthesis process moves on to another chemical state (e.g., downstream from the chemical state 326) to repeat the Markov decision process for a subsequent timestep. In one or more embodiments, FIG. 3B illustrates a hierarchy of molecule generation actions to progress from one timestep in a Markov decision process to a subsequent timestep. In other words, FIG. 3B illustrates that a selection of a particular chemical reaction (bi-molecular) further requires a selection of an additional reactant to be applied to the current chemical state.

Although FIG. 3B describes the chemical-reaction action space as including the uni-molecular reaction 330 and the bi-molecular reaction 332, in one or more embodiments, the SynFlowNet system 100 further utilizes the chemical-reaction action space that includes tri-molecular reactions and additional multi-order reactions. Specifically, for multi-order reactions exceeding bi-molecular reactions, the SynFlowNet system 100 further implements additional neural network layer to generate additional action prediction scores for selecting additional reactants to satisfy the multi-order reactions.

FIGS. 4A-4B illustrates example diagrams of the SynFlowNet system 100 using binary Morgan fingerprints to represent molecular building blocks. In one or more embodiments, to handle large sets of molecular building blocks (up to 200K), the SynFlowNet system 100 represents molecular building blocks 400 as binary Morgan fingerprints 402 and computes the probability of sampling a particular building block from the normalized dot product between fingerprint representation and the vector representation of the current state.

For instance, the molecule generation action of add reactant (and/or add first reactant) are associated with a set of molecular building blocks corresponding to chemical reactions. During the generation of the action prediction scores, the SynFlowNet system 100 generates action prediction scores for all the molecular building blocks 400 associated with the molecule generation actions. Specifically, if add reactant has 100,000 molecular building blocks, the SynFlowNet system 100 generates an action prediction score for each of the 100,000 molecular building blocks and selects the molecular building block with the highest action prediction score.

FIG. 4A shows that the SynFlowNet system 100 takes the molecular building blocks 400 and generates the binary Morgan fingerprints 402 for each of the molecular building blocks 400. In one or more embodiments, a binary morgan fingerprint refers to a molecule fingerprint that represents chemical structures in a format for computer analysis. Specifically, the SynFlowNet system 100 uses a binary Morgan fingerprint to represent a molecular building block as a graph, with atoms as nodes and bonds as edges. For example, the SynFlowNet system 100 generates the binary Morgan fingerprint by exploring around each atom of a molecular building block (e.g., within a threshold radius) and encodes the atom and bonds within its threshold radius. Furthermore, the SynFlowNet system 100 hashes each molecular building block to 1's which represents a presence of a substructure in the molecular building block, and to 0's which represents an absence of a substructure. Moreover, the SynFlowNet system 100 generates binary Morgan fingerprints at a fixed-length bit vector.

FIG. 4B shows that from the binary Morgan fingerprints 402 corresponding to different molecular building blocks, the SynFlowNet system 100 takes a normalized dot product 408 of the binary Morgan fingerprints 402 and a vector representation 406 of a current viable chemical state 404 to generate action prediction scores 410 (logits). Further, FIG. 4B shows the SynFlowNet system 100 further uses a softmax layer 412 to generate probabilities 414 (refined score) and samples a molecular building block 416 from the set of molecular building blocks to represent the molecule generation action (e.g., a molecule generation action of add first reactant).

Although the above discussion describes the SynFlowNet system 100 generating action prediction scores for all molecular building blocks associated with the molecule generation actions of add first reactant and add reactant, in one or more embodiments, the SynFlowNet system 100 first generates action prediction scores for each of the broad molecule generation actions. Further, after sampling a molecule generation action (e.g., such as add first reactant), the SynFlowNet system 100 then generates binary Morgan fingerprints for the molecular building blocks associated with the sampled molecule generation action (e.g., add first reactant). From the process shown in FIG. 4B, the SynFlowNet system 100 then selects the molecular building block with the highest probability score.

FIG. 5 illustrates an example diagram of the SynFlowNet system 100 generating reward measures and modifying parameters of the chemically constrained forward policy network in accordance with one or more embodiments. For example, FIG. 5 shows the SynFlowNet system 100 using a chemically constrained forward policy network 500 to sequentially build molecular structures. Specifically, FIG. 5 shows an initial viable chemical state 502, intermediate viable chemical states 504, a first molecular structure 506, a second molecular structure 508, and a third molecular structure 510.

As shown, for the first molecular structure 506, the second molecular structure 508, and the third molecular structure 510, the SynFlowNet system 100 generates reward measures (e.g., a first reward measures 512, a second reward measure 514, and a third reward measure 516). In one or more embodiments, the SynFlowNet system 100 builds a molecular structure and further determines a reward measure for building the molecular structure. Specifically, the reward measure refers to a value that quantifies how well a model (e.g., the chemically constrained forward policy network 500) performs for a specific task or objective. For example, an agent model (e.g., the chemically constrained forward policy network 500) makes decisions and receives feedback in the form of rewards, where the rewards indicate how desirable or undesirable an outcome of an action or a sequence of actions was. In some instances, the agent has an objective to maximize the reward. As described above, for building molecular structures, there can be a variety of objectives for a reward (e.g., prediction of a binding affinity to a specific protein, molecular properties such as stability and reactivity, and predicting a binding affinity to a target transcription factor).

In one or more embodiments, the SynFlowNet system 100 uses a reward function to determine the reward measures. Specifically, the SynFlowNet system 100 uses a reward function that assigns a value (e.g., reward) to a state (e.g., a final molecular state) of the chemically constrained forward policy network 500. For instance, the SynFlowNet system 100 uses the reward function to generate a value that quantifies the immediate benefit of performing/synthesizing a molecular structure. Furthermore, the value of the reward acts as a training measure to help optimize decision making by the chemically constrained forward policy network 500.

In one or more embodiments, the SynFlowNet system 100 trains the chemically constrained forward policy network 500 on a number of different reward functions/reward targets. For example, the SynFlowNet system 100 defines a reward function as the normalized negative binding energy as predicted by a pretrained proxy model, described in Bengio, E., Jain, M., Korablyov, M., Precup, D., and Bengio, Y., Flow network based generative models for non-iterative diverse candidate generation, Advances in Neural Information Processing Systems, 34:27381-27394, 2021a.; Bengio, Y., Deleu, T., Hu, E. J., Lahlou, S., Tiwari, M. Specifically, the reward function for normalized negative binding energy uses the pretrained proxy model which is trained on molecules docked with AutoDock Vina for the soluble epoxide hydrolase (sEH) protein target (a well-studied protein which plays part in respiratory and heart disease), described in Oleg Trott and Arthur J. Olson, Autodock Vina: improving the speed and accuracy of docking with a new scoring func-tion, efficient optimization, and multithreading, Journal of Computational chemistry, 31(2):455-461, 2010, doi: 10.1002/jcc.21334.

In some embodiments, the SynFlowNet system 100 uses oracle functions which provide machine learning proxies trained to fit to experimental data to predict bioactivities against their corresponding disease targets. Specifically, the two targets used are gsk3β described in Yibo Li, Liangren Zhang, and Zhenming Liu, Multi-objective de novo drug design with conditional graph generative model, Journal of cheminformatics, 10:1-24,2018, and dopamine receptor D2 (DRD2) described in Marcus Olivecrona, Thomas Blaschke, Ola Engkvist, and Hongming Chen, Molecular de-novo design through deep reinforcement learning, Journal of cheminformatics, 9:1-14, 2017a.

In one or more embodiments, the SynFlowNet system 100 adapts to additional targets using GPU accelerated Vina docking. Specifically, the SynFlowNet system 100 prepares receptors for docking and the center of the docking is defined as the center of mass for the ligand. For instance, the SynFlowNet system 100 performs GPU-accelerated Vina docking to adapt to other targets as described in Shidi Tang, Ji Ding, Xiangyu Zhu, Zheng Wang, Haitao Zhao, and Jiansheng Wu, Vina-gpu 2.1: towards further optimizing docking speed and precision of autodock vina and its derivatives, bioRxiv, 2023, doi: 10.1101/2023.11.04.5655429. Thus, FIG. 5 illustrates the SynFlowNet system 100 using the reward measures to train the chemically constrained forward policy network 500 to generate forward trajectories that maximize reward (e.g., as indicated by a target objective).

FIG. 6 illustrates an example diagram of the SynFlowNet system 100 generating a generative flow network trajectory balance loss to modify parameters of the chemically constrained forward policy network in accordance with one or more embodiments. For example, FIG. 6 shows the SynFlowNet system 100 comparing a chemically constrained forward policy network 600 with a chemically constrained backward policy network 602 to generate a generative flow network trajectory balance loss 604.

In one or more embodiments, the SynFlowNet system 100 determines the generative flow network trajectory balance loss 604 for each generated trajectory by the generative flow network. Specifically, the SynFlowNet system 100 compares reward measures of the chemically constrained forward policy network 600 and backward reward measures of the chemically constrained backward policy network 602 to generate the generative flow network trajectory balance loss 604. Thus, the SynFlowNet system 100 generates generative flow network trajectory balance losses for multiple generated trajectories of the generative flow network.

For instance, the SynFlowNet system 100 generates a generative flow network trajectory balance loss by comparing a forward measure of probability flow between states for the chemically constrained forward policy network 600 and a backward measure of probability flow between states for the chemically constrained backward policy network 602. To illustrate, the generative flow network trajectory balance loss 604 reflects the probability flow between states for the chemically constrained forward policy network 600 proportional to reward measures combined with the backward measure of probability flow between states for the chemically constrained backward policy network 602.

Generative flow networks are a class of probabilistic models that learn a stochastic policy to generate objects x through a sequence of actions, with probability proportional to a reward R(x). The sequential construction of objects x can be described as a trajectory t€T in a directed acyclic graph (DAG) G=(S, €), starting from an initial state so and using actions a to transition from a state to the next: s→s′.

For instance, the SynFlowNet system 100 trains the generative flow network to sample over a space of synthesizable molecules, which are assembled from an action space of chemical reactions and reactants (e.g., molecular building blocks). Further, a graph neural network with a graph transformer architecture is used to produce state-conditional distribution over the actions. Specifically, the SynFlowNet system 100 represents a state as a molecular graph in which nodes contain atom features and edge attributes are bond type and indices of the atoms which are its attachment points.

In one or more embodiments, the representation of nodes in the molecular graph is augmented with a fully-connected virtual node, which is an embedding of the conditional encoding of the desired sampling temperature (e.g., a parameter that influences whether the generative mechanism tends towards randomness or diversity), obtained using a multi-layer perceptron. The sampling temperature is controlled by a temperature parameter beta, which also plays a role in reward modulation, allowing for exponential scaling of the rewards (by making rewards received during training equal to R^{β}. In some embodiments, the SynFlowNet system 100 samples beta from multiple distributions and uses a constant distribution. For instance, the SynFlowNet system 100 uses a thermometer encoding of the temperature as described in Jacob Buckman, Aurko Roy, Colin Raffel, and Ian goodfellow, Thermometer encoding: One hot way to resist adversarial examples, In International Conference on Learning Representations, 2018.

In one or more embodiments, the SynFlowNet system 100 trains the generative flow network (e.g., containing the chemically constrained forward policy network 600 and the chemically constrained backward policy network 602) using the trajectory balance objective and is thus parameterized by forward and backward action distributions (P_{F} and P_{B}) and an estimation of the partition function Z=Σ_{t€T} F (T) (e.g., a partition function defines and guides the generative process). For instance, a generative flow network uses a forward policy P_{F} (−|s), which is a distribution over the children of state s, to sample a sequence of actions based on the current states. Similarly, a backward policy P_{B}(−|s) is the distribution over the parent of state s, and can be used to calculate probabilities of backward actions, leading from terminal to initial states.

In some embodiments, the SynFlowNet system 100 optimizes generative flow networks to satisfy balance conditions of flow. As discussed above, flow measures indicate a total cumulative reward. For further elaboration, the SynFlowNet system 100 models the flow measures (F(s)) such that the flows going through states are conserved (e.g., an input state such as an intermediate biochemical structure). Specifically, terminal states (e.g., corresponding to fully constructed biochemical structures) absorb non-negative units of flow, and intermediate states have as much flow coming into them (from parent nodes) as flow coming out of them (to children nodes). To illustrate, in some embodiments, the SynFlowNet system 100 represents flow measures for a partial trajectory (sₙ, . . . , sₘ) (e.g., incomplete trajectories that have not reached a fully constructed molecular structure) as follows:

$$F ( {s}_{n} ) {\prod }_{i = n}^{m - 1} {P}_{F} ( {s}_{i + 1} \vert {s}_{i} ) = F ( {s}_{m} ) {\prod }_{i = n}^{m - 1} {P}_{B} ( {s}_{i} \vert {s}_{i + 1} )$$

In the above notation, P_{F} and P_{B} represent forward and backward policies, respectively. Specifically, the forward policy and the backward policy represents distributions over children and parents of flow emanating forward and backward from a specific state. For instance, the SynFlowNet system 100 constructs for terminal (leaf) states as follows F(s)=R(s). Another way that the SynFlowNet system 100 represents the forward backward policies is through edge flows as follows F(s→s′)=F(s) P_{F}(s′|s). Moreover, in some embodiments, the SynFlowNet system 100 represents flow conditions as preserving incoming flows and outgoing flows for all states s E S as:

$${\sum }_{{s}_{i} ∈ aPar ( s )} F ( {s}_{i} \to s ) = {\sum }_{{s}_{o} ∈ Chld ( s )} F ( s \to {s}_{o} )$$

By constructing the edge flow F(s→S_{T}) to a terminal state S_{T}, the SynFlowNet system 100 represents this as R(S_{T}) which indicates the flow corresponding to taking a stop action, and the initial state S, which has no parents, only has to account for the flow of its children (e.g., because it is a source in the network).

To illustrate, the SynFlowNet system 100 generates the generative flow network trajectory balance loss 604 as described in Nikolay Malkin, Moksh Jain, Emmanuel Bengio, Chen Sun, and Yoshua Bengio, Trajectory balance: Improved credit assignment in gflownets, CoRR, abs/2201.13259, 2022. For instance, the SynFlowNet system 100 represents the generative flow network trajectory balance loss 604 as:

$${L}_{TB} ( T ) = {( log \frac{{Z}_{θ} {\prod }_{t = 1}^{T} {P}_{F} ( {s}_{t + 1} \vert {s}_{t} ; θ}{R ( \text{x)} {\prod }_{t = 1}^{T} {P}_{B} ( {s}_{t - 1} \vert {s}_{t} ; θ} )}^{2}$$

The above notation indicates that the generative flow network trajectory balance loss 604 is equivalent to a log of the forward measure of probability flow between states for the chemically constrained forward policy network 600 proportional to the reward measures combined with the backward measure of probability flow between states.

In one or more embodiments, the SynFlowNet system 100 uses the generative flow network trajectory balance loss 604 to learn forward and backward policies parameterized by parameters of generative flow network (e.g., theta) to estimate the partition function discussed above. Specifically, the partition function discussed above indicates a sum of all possible forward flow values over the entire space of generative trajectories or outcomes. Specifically, the SynFlowNet system 100 uses the partition function as a normalizing constant to make probabilities assigned to different generated trajectories compatible (e.g., sum to 1). In other words, the SynFlowNet system 100 uses the partition function to ensure that probabilities of a particular trajectories are proportional to their rewards by normalizing flow values during the training/optimization process.

In one or more embodiments, the SynFlowNet system 100 uses a graph neural network based on a graph transformer architecture to parameterize the forward and backward policies. Specifically, the SynFlowNet system 100 defines the action space using separate multi-layer perceptrons for each molecule generation action type (see above). For instance, the SynFlowNet system 100 trains the forward and backward policy networks in an online fashion, such that it learns exclusively from trajectories sampled from the GFlowNet policy, without relying on an external dataset of trajectories or a set of target molecules. In some embodiments, the SynFlowNet system 100 uses offline training, which makes use of external datasets as starting point for exploring the molecular space.

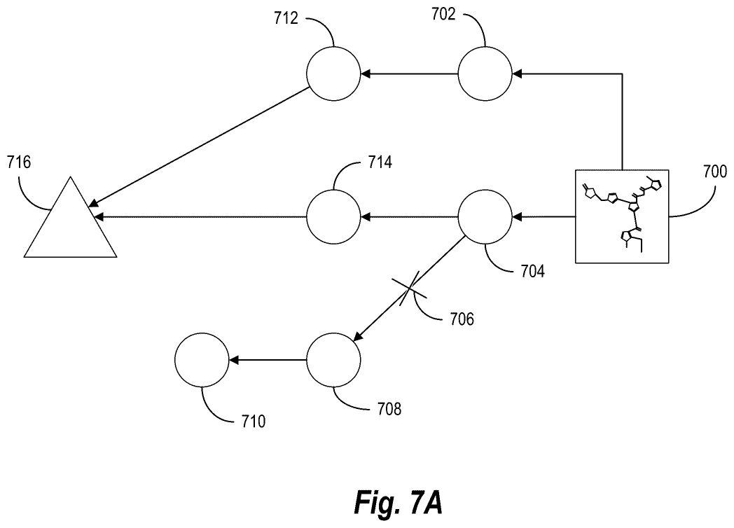

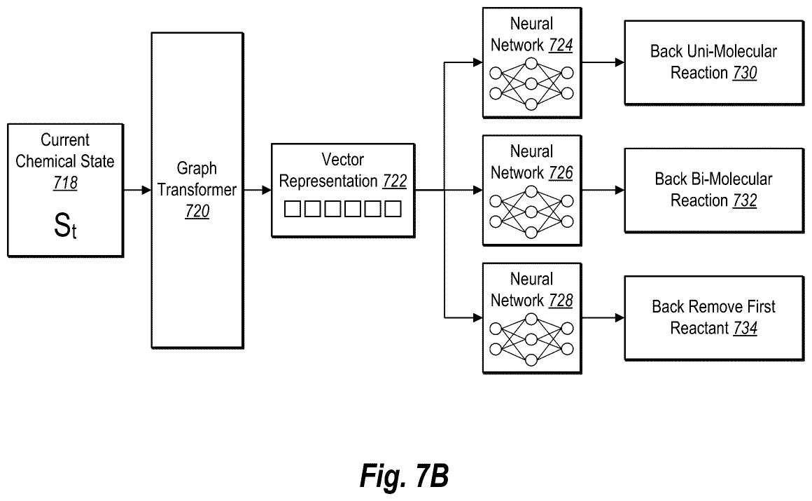

As mentioned above, the SynFlowNet system 100 trains a chemically constrained backward policy network with a separate objective from the chemically constrained forward policy network. FIGS. 7A-7B illustrate example diagrams of the SynFlowNet system 100 deconstructing a molecular structure with a series of backward actions. FIG. 7A shows the SynFlowNet system 100 generating backward trajectories (e.g., retrosynthesis) and constraining the backward policy network to viable backward trajectories.

FIG. 7A illustrates the SynFlowNet system 100 starting from a final molecular structure 700 and deconstructing the final molecular structure 700. Specifically, FIG. 7A shows a first backward trajectory that includes a first node 702, a second node 712, and an initial viable chemical state 716. Further, FIG. 7A shows a second backward trajectory that includes a third node 704, a fourth node 714, and the initial viable chemical state 716. Moreover, FIG. 7A shows a third backward trajectory that includes the third node 704, a fifth node 708, and a sixth node 710. Additionally, FIG. 7A shows an “X” which indicates that the third backward trajectory is a non-viable backward trajectory, because it leads to an initial state that is not an initial viable chemical state.

In one or more embodiments, a viable backward trajectory refers to a trajectory moving from a molecular structure (e.g., a final or intermediate chemical state) to an initial viable chemical state. In other words, a viable backward trajectory includes terminating/ending in an initial state that was used in a forward-generated trajectory (and/or another viable chemical state). As mentioned above, in some embodiments, the SynFlowNet system 100 trains a chemically constrained forward policy network to match a chemically constrained backward policy network. For instance, the choice of how a backward policy network is trained impacts the overall training of generative flow networks and sample quality (e.g., during molecular structure synthesis).

In some embodiments, the SynFlowNet system 100 parameterizes the chemically constrained backward policy network and trains the backward policy network and the forward policy network simultaneously using the trajectory balance objective discussed above. For instance, given the synthesis pointed directed acyclic graph (DAG, where G=(S, ¿), the SynFlowNet system 100 defines a forward probability function P_{F} and a backward probability function P_{B} both consistent with G. Contrary to previous fragment-based or atom-based molecule-generation environments (e.g., existing systems), where any backward action can lead to so (removing nodes and edges sequentially will lead to an empty graph), the SynFlowNet system 100 faces an issue of returning to an initial state that is not an initial viable chemical state (e.g., part of the forward-generated trajectories).

Defining the chemically constrained backward policy network in a reaction-based environment (e.g., a chemical-reaction action space) is non-trivial. For instance, not every parent state (obtained by applying a reaction template backwards) will ensure that there exists a sequence of actions that leads back to an initial building block, and therefore so. Specifically, the masking described above in FIG. 3C is insufficient to account for a failure to return to a viable parent state, as masking does not ensure that the state obtained is further decomposable into building blocks. Thus, in some embodiments, to maintain a pointed DAG, the SynFlowNet system 100 avoids flows that are assigned to non-viable parent states (e.g., initial states that are not included in the forward-generated trajectories).

Moreover, if the SynFlowNet system 100 uses a uniform backward policy for the chemically constrained backward policy network, the SynFlowNet system 100 will fail at achieving viable chemical states, as it will assign positive flow to every backward action, including those leading to states that are not attainable from forward trajectories initialized in so. To address this issue, SynFlowNet system 100 uses various training schemes for a parameterized chemically constrained backward policy network that forces backward-constructed trajectories to end in so (initial viable chemical states).

In one or more embodiments, when the SynFlowNet system 100 traverse a Markov decision process backwards, the SynFlowNet system 100 reduces the probability of exiting the Markov decision process (defined by the chemical-reaction action space), by training the chemically constrained backward policy network to avoid paths that do not terminate in initial viable chemical states. FIG. 7B shows the SynFlowNet system 100 using a graph transformer 720 to process a current chemical state 718 to generate a vector representation 722. Furthermore, FIG. 7B shows the SynFlowNet system 100 feeding the vector representation 722 into a plurality of neural networks (e.g., neural networks 724-728) where the plurality of neural networks generate action prediction scores for backward actions.

To illustrate, FIG. 7B shows the SynFlowNet system 100 generating an action prediction score for a back uni-molecular reaction 730 (e.g., a reaction that transforms the current chemical state), an action prediction score for a back bi-molecular reaction 732 (e.g., a reaction that involves a reactant and the current chemical state) and generating an action prediction score for a back remove first reactant 734. Specifically, the back uni-molecuar reaction 730 yields the reactant molecule for the bi-molecular reaction 732.

Further, the back bi-molecular reaction causes the SynFlowNet system 100 to obtain two reactants (i.e., a reactant and the previous chemical state), and the molecule that is not a building block becomes the subsequent step (e.g., previous state in the molecular graph). In some embodiments, if the two resulting reactants are both molecular building blocks (e.g., which happens at the beginning of the forward trajectory), the SynFlowNet system 100 selects the molecule to populate the next state (e.g., the previous state in the molecular graph) with a probability of p=1/2 from the two molecular building blocks. Moreover, the back remove first reactant 734 is a final action by the SynFlowNet system 100 in a single backward trajectory that leads to an empty molecular graph so.

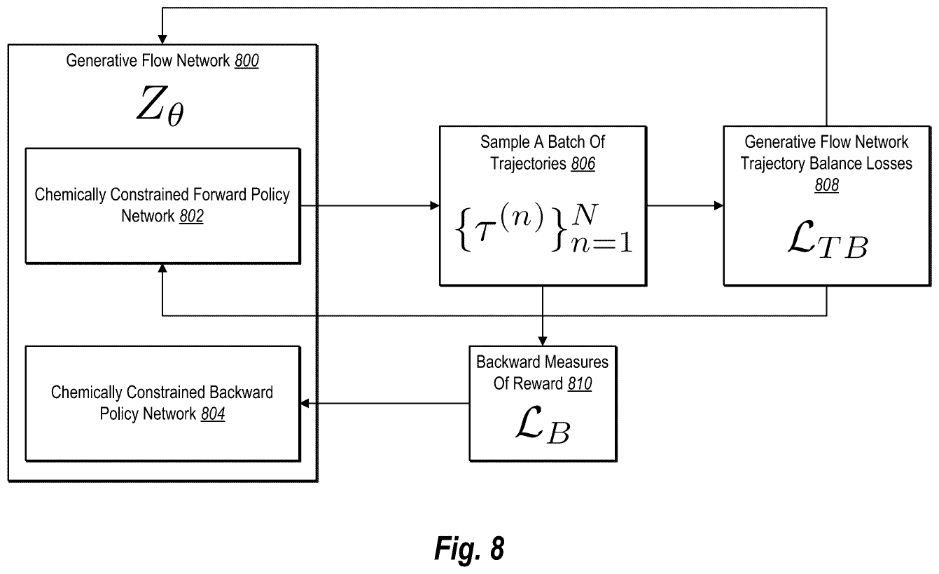

As mentioned above, in some implementations, the SynFlowNet system 100 can train a chemically constrained backward policy network only on forward-generated trajectories. FIG. 8 illustrates an example diagram of the SynFlowNet system 100 modifying parameters of a chemically constrained backward policy network using a maximum likelihood objective. For example, FIG. 8 shows the SynFlowNet system 100 using a generative flow network 800 that contains a chemically constrained forward policy network 802 and a chemically constrained backward policy network 804.

As shown, the SynFlowNet system 100 performs an act 806 of sampling a batch of trajectories. Specifically, the SynFlowNet system 100 samples a batch of trajectories from the forward direction (e.g., trajectories generated by the chemically constrained forward policy network 802). Furthermore, FIG. 8 shows the SynFlowNet system 100 generating generative flow network trajectory balance losses 808 from the sampled batch of trajectories. For instance, the SynFlowNet system 100 modifies parameters of the generative flow network 800 (e.g., Ze which in some embodiments represents the partition function discussed above) and specifically the chemically constrained forward policy network 802 based on the generative flow network trajectory balance losses 808 (e.g., as discussed above in FIG. 6).

In some embodiments, the SynFlowNet system 100 uses a maximum likelihood over observed trajectories (e.g., already generated forward trajectories) to train the chemically constrained backward policy network. Specifically, the SynFlowNet system 100 uses the maximum likelihood objective to ensure that the flow induced by the backward policy is concentrated around observed (training) states, making the chemically constrained backward policy network 804 pessimistic about unobserved intermediate states having a viable flow.

As shown in FIG. 8, the SynFlowNet system 100 determines backward measures of reward 810 from the sampled batch of forward generated trajectories to train the chemically constrained backward policy network 804. In one or more embodiments, the term “backward measure of reward” refers to a measure that indicates a cumulative probability of reward. For instance, a flow measure can be modeled as energy flow, where the energy flow is proportional to the probability of reward following from choosing a particular option. For example, the flow measure indicates a total reward for moving from one state to another (e.g., an additional chemical state to an initial viable chemical state), where the reward reflects the current state and additional upstream states.

In one or more embodiments, the SynFlowNet system 100 represents training the chemically constrained backward policy network 804 using the maximum likelihood objective over trajectories generated from the chemically constrained forward policy network as:

$${L}_{B} ( {θ}_{B} ) = {𝔼}_{T ∼ {P}_{F}} [ - log {P}_{B} ( T ; {θ}_{B} ) ]$$

The above notation indicates the SynFlowNet system 100 generates the backward measures of reward with the maximum likelihood objective by using backward trajectories that correspond to forward-generated trajectories.

To illustrate, the SynFlowNet system 100 generates trajectories using the chemically constrained forward policy network 802, updates the chemically constrained forward policy network 802 according to the generative flow network trajectory balance losses 808 discussed above, and then updates the chemically constrained backward policy network 804 according to the above notation. The following algorithm further illustrates using maximum likelihood objective for the chemically constrained backward policy network 804:

Algorithm 1 Training of Maximum Likelihood Backward
Policy for GFlowNets

1: Initialize the forward policy P_{F}, backward policy P_{B}, and Z_{θ}.
2. repeat
$3. Sample a batch of trajectories {\{ {T}^{( n )} \}}_{n = 1}^{N} from {P}_{F}$
4. Update P_{F} and Z_{θ} to minimize L_{TB} using
$5. Update {P}_{B} to minimize {L}_{TB} over {\{ {T}^{( n )} \}}_{n = 1}^{N}$
6. until convergence

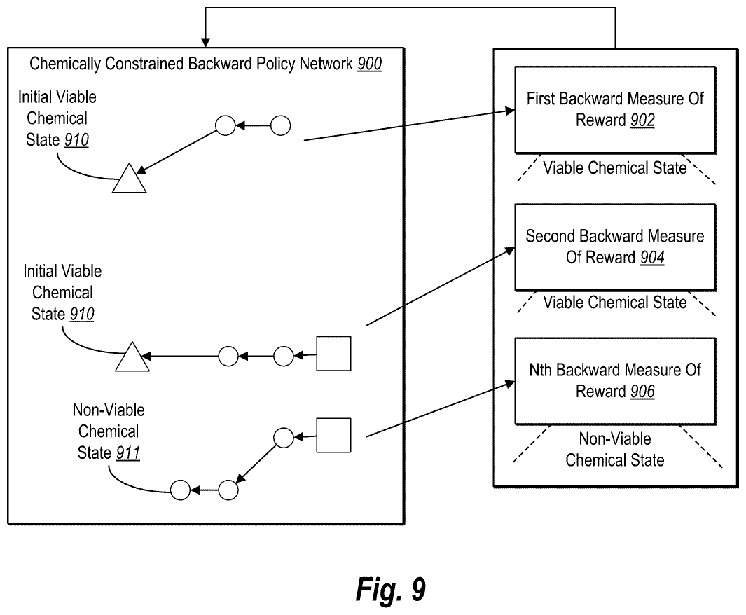

FIG. 9 illustrates an example diagram of the SynFlowNet system 100 modifying parameters of a chemically constrained backward policy network using reinforcement learning. In one or more embodiments, while the maximum-likelihood approach presented above in FIG. 8 is sufficient to limit the backward policy network in allocating flow to paths that do not connect back to s₀, it restricts the exploration of the backward policy network by encouraging the forward policy network to collapse on a single path for each terminal molecule. To allow a chemically constrained backward policy network 900 to exclude (e.g., ban) erroneous paths while retaining a higher entropy, the SynFlowNet system 100 utilizes policy gradient methods. Specifically, the SynFlowNet system 100 maximizes an expected backwards reward of a backward policy network via REINFORCE, which is suitable for short trajectory environments like a reaction-based Markov decision process.

In one or more embodiments, the SynFlowNet system 100 utilizes reinforcement learning to generate one or more backward trajectories from an additional chemical state (e.g., a final or intermediate chemical state) to an initial chemical state. Specifically, the SynFlowNet system 100 utilizes reinforcement learning to improve the explorative capabilities of the backward policy network such that it is not restrained to paths that align with just the forward trajectories.

In other words, the SynFlowNet system 100 utilizes reinforcement learning such that the backward trajectories explore paths that were not generated by the chemically constrained forward policy network. Furthermore, the SynFlowNet system 100 determines a backward measure of reward by comparing the initial chemical state (e.g., generated as part of the backward trajectory) with the initial viable chemical states (e.g., the starting reactant for forward-generated trajectories). For instance, the SynFlowNet system 100 trains parameters of the chemically constrained backward policy network 900 based on the backward measures of reward.

FIG. 9 shows the SynFlowNet system 100 generating a plurality of backward trajectories. For example, FIG. 9 shows the SynFlowNet system 100 generating a first backward measure of reward 902 from a first backward trajectory, a second backward measure of reward 904 for a second backward trajectory, and an Nth backward measure of reward 906 for a Nth backward trajectory. Specifically, the SynFlowNet system 100 determines the backward measures of reward by comparing an initial chemical state (the state the backward trajectory terminates at) with an initial viable chemical state 910 (the initial state of the forward generated trajectory or another viable chemical state).

As shown in FIG. 9, the SynFlowNet system 100 generates the first backward trajectory that terminates at the initial viable chemical state 910, thus the first backward measure of reward 902 corresponds to a viable chemical state (e.g., the SynFlowNet system 100 utilizes reinforcement learning to give a positive reward, i.e., +1, for terminating at the initial viable chemical state 910). Moreover, the SynFlowNet system 100 generates the second backward trajectory that also terminates at the initial viable chemical state 910. Likewise, the second backward measure of reward 904 corresponds to a viable chemical state. Furthermore, FIG. 9 shows the Nth backward trajectory terminates at a non-viable chemical state 911, and thus the Nth backward measure of reward 906 corresponds to a non-viable chemical state (e.g., the SynFlowNet system 100 utilizes reinforcement learning to give a negative reward, i.e., −1, for terminating at the non-viable chemical state 911).

In one or more embodiments, the SynFlowNet system 100 represents the reinforcement learning for the chemically constrained backward policy network 900 as:

$${J}_{B} ( {θ}_{B} ) = {𝔼}_{T ∼ {P}_{F} , {P}_{B}} [ {R}_{B} ( T ) ] - α H ( {P}_{B} )$$

In the above notation, H(P_{B})=− [symbol] _{T~P}_{_{B}} [log P_{B}(t))] is an entropy term and the reward R_{B} is set to 1 for a trajectory that ends in s₀ and −1 otherwise. In this setting, the SynFlowNet system 100 trains the chemically constrained backward policy network not only on trajectories generated by the forward policy, but also on newly generated backward trajectories sampled directly from the backward policy network.

In some embodiments, training the chemically constrained backward policy network 900 to navigate back to s₀ is analogous to a retrosynthesis problem. As mentioned above, the SynFlowNet system 100 trains the backward policy network against a different objective than the forward policy network, and a similar strategy could also be employed to fold additional preferences over different synthesis routes leading to the same terminal state. Specifically, the SynFlowNet system 100 could train the backward policy network against a specifically tailored objective that takes into account the synthesis costs of a particular path.

In one or more embodiments, the SynFlowNet system 100 uses algorithm 2 for training the chemically constrained backward policy network 900 using reinforcement learning:

Algorithm 2 Training of REINFORCE Backward Policy for GFlowNets

1: Initialize the replay buffer B, forward policy P_{F}, backward policy P_{B}, and Z_{θ}.
2. repeat
$3. Sample a batch of trajectories {\{ {T}_{F}^{( n )} \}}_{n = 1}^{N} from {P}_{F}$
$4. Update B ← B ⋃ {\{ {T}_{F}^{( n )} \}}_{n = 1}^{N} .$
5. sample k random trajectories from B and extract their final states s_{F} to sample backward
$trajectories {\{ {T}_{B} \}}_{k = 1}^{K} from {P}_{B} .$
$6. Update {P}_{F} and {Z}_{θ} to minimize {L}_{TB} using {\{ {T}_{F}^{( n )} \}}_{n = 1}^{N} .$
$7. Update {P}_{B} to minimize {J}_{B} over {\{ {T}_{B} \}}_{k = 1}^{K} ⋃ {\{ {T}_{F}^{( n )} \}}_{n = 1}^{N} .$
8. until convergence

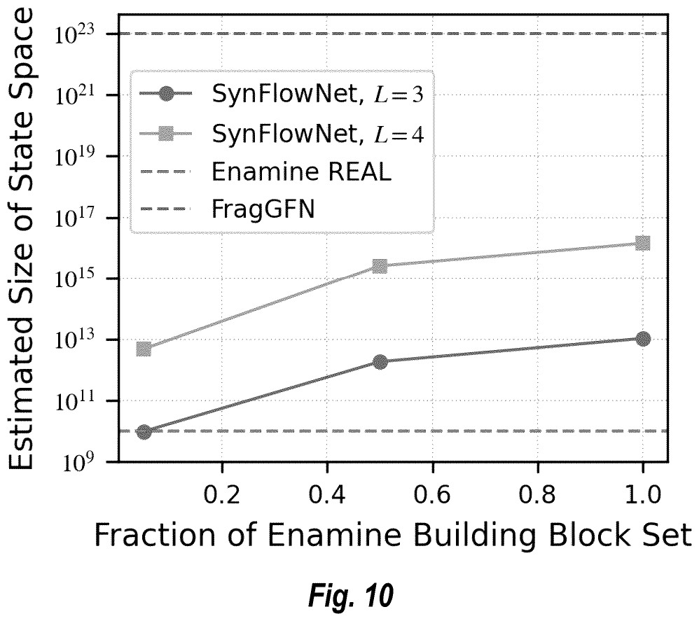

FIG. 10 illustrates an example diagram comparing the estimated size of the state space for the SynFlowNet system 100 with the estimated size of the state space for existing baselines in accordance with one or more embodiments. For example, FIG. 10 shows experimenters estimating the size of the state space induced by the chemical-reaction action space of the SynFlowNet system 100. Specifically, experimenters have generative flow networks learn Z=log Σₓ R(x)), and the experimenters train a model with R=1 for all terminal states to estimate their total count.

For instance, the experimenters train the model with the just-mentioned parameters and find that the SynFlowNet system 100 (using a different number of building blocks and a maximum trajectory length of 3, L=3) matches the size of the Enamine REAL space (e.g., a virtual library of chemical compounds, which is indicated as the bottom dotted line in the graph). For example, the size of the state space quickly increases with an increase in the number of building blocks. In one or more embodiments, the experimenters use a full set of 105 reactions.

Further, in one or more embodiments, to improve synthetic accessibility of samples, the SynFlowNet system 100 is inherently constrained by the initial set of available building blocks. To cover a large chemical space, it is crucial to use an extensive molecular building block collection. Specifically, as shown in FIG. 10, the SynFlowNet system 100 uses a model that demonstrates scalability to accommodate larger sets of molecular building blocks, both in terms of training efficiency and overall performance.

As illustrated, the dotted solid line near the bottom of the graph indicates the SynFlowNet system 100 using a model with a maximum trajectory length of 3 and the solid square line above the dotted solid line shows the SynFlowNet system 100 using a model with a maximum trajectory length of 4. Thus, FIG. 10 shows that the action space of the SynFlowNet system 100 being defined as reaction-constrained models, considerably limits the exploration of the chemical space. In contrast generative flow networks that are fragment-based (e.g., existing systems, indicated by the dotted line near the top of the graph) explore a space around ten orders of magnitude larger.

In one or more embodiments, the existing systems use FragGEN training. Specifically, FragGFN training includes obtaining fragments and their attachment points by following protocols described in Wengong Jin, Regina Barzilay, and Tommi Jaakkola, Junction Tree Variational Autoencoder for Molecular Graph Generation, arXiv preprint arXiv: 1802.-4364, 2019.

To further accommodate to larger sets of molecular building blocks, the SynFlowNet system 100 utilizes the binary Morgan fingerprints (discussed above in FIGS. 4A-4B). Specifically, the SynFlowNet system 100 changes the representation of molecular building blocks and their selection mechanism. For instance, instead of the weight of the matrix of the mapping from hidden units to logits (e.g., action prediction scores) associated with molecular building blocks to be randomly initialized, the SynFlowNet system 100 fixes the molecular building blocks to be the matrix of binary morgan fingerprints. Thus, the SynFlowNet system 100 further improves the ability of models to sample from a robust and extensive state space by utilizing Morgan fingerprints.

Accordingly, FIG. 10 shows that the estimated size of the state space for SynFlowNet system 100 is much more manageable than the fragGEN (existing systems). Specifically, the SynFlowNet system 100 avoids potentially unrealistic synthesis of molecular structures and further avoids efficiency issues of traversing a large state space that is present with most existing systems.

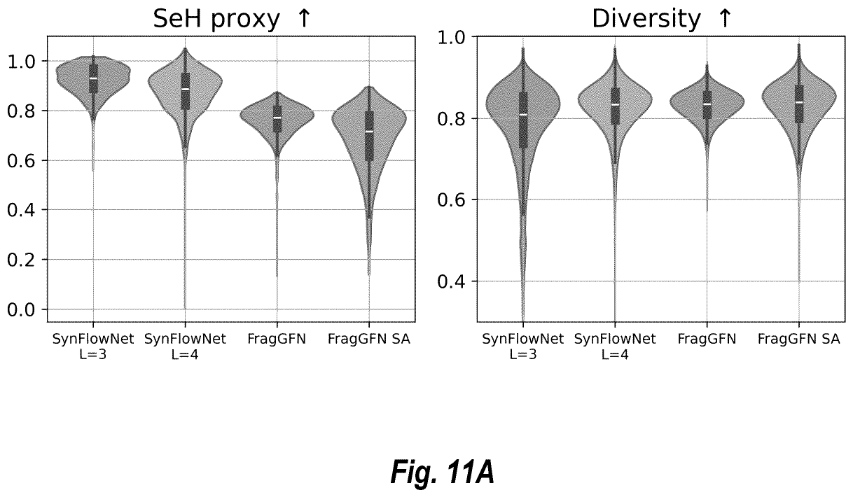

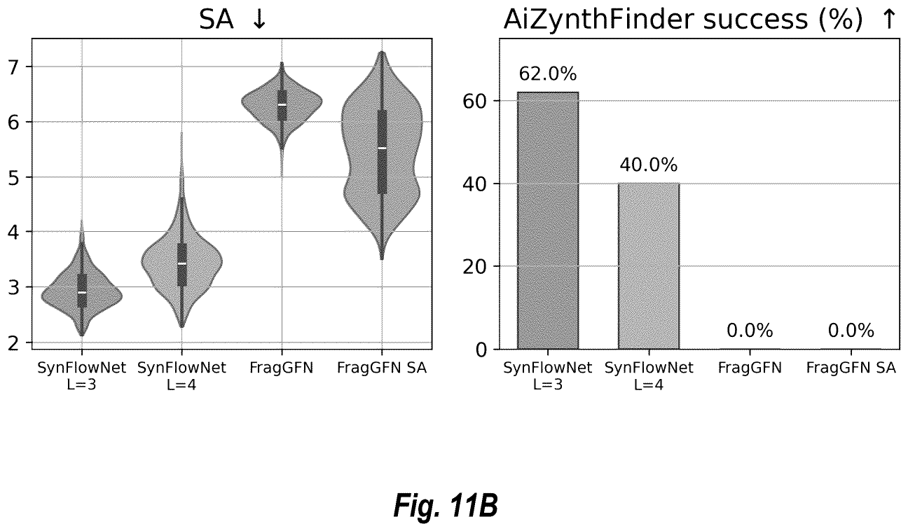

FIGS. 11A-11B illustrates that the SynFlowNet system 100 using a reaction-based Markov decision process greatly improves the synthesizability of the generated molecules in accordance with one or more embodiments. For example, the left graph in FIG. 11A shows experimenters comparing a fragment-based space (e.g., existing systems) and a chemical-reaction action space of the SynFlowNet system 100. Specifically, the left graph in FIG. 11A shows that reward (e.g., indicated as the sEH proxy, which is a reward function defined as the normalized negative binding energy) of the chemical-reaction action space outperforms reward of the fragment-based space for existing systems. For instance, the left graph in FIG. 11A shows that for both FragGFN (fragment-based space) and FragGEN SA (fragment-based space with synthetic accessibility scores), the average reward is lower than the chemical-reaction action space of the SynFlowNet system 100.

Moreover, the right graph in FIG. 11A shows the diversity of the sampling from a chemical-reaction action space compared with a fragment-based action space. Specifically, experimenters measure diversity as the average Tanimoto distances between molecular fingerprints. For instance, the right graph in FIG. 11A shows that the diversity of the SynFlowNet system 100 is better than the diversity of the FragGFN models.

The left graph in FIG. 11B illustrates the synthetic accessibility of the SynFlowNet system 100 compared with existing systems. Specifically, FIG. 11B shows that the SynFlowNet system 100 outperforms existing systems in terms of synthetic accessibility (e.g., a lower synthetic accessibility score indicates generated molecular structures are more synthesizable). Further, the right graph in FIG. 11B illustrates AiZynthFinder success percentage (e.g., artificial intelligence generated predictions to suggest feasible synthetic routes for a target molecules, where the success percentage generally refers to its ability to find a viable synthetic pathway). As indicated, the higher the AiZynthFinder percentage, the better it is at finding a viable synthetic pathway. Specifically, the right graph in FIG. 11B illustrates that the SynFlowNet system 100 significantly outperforms existing systems.

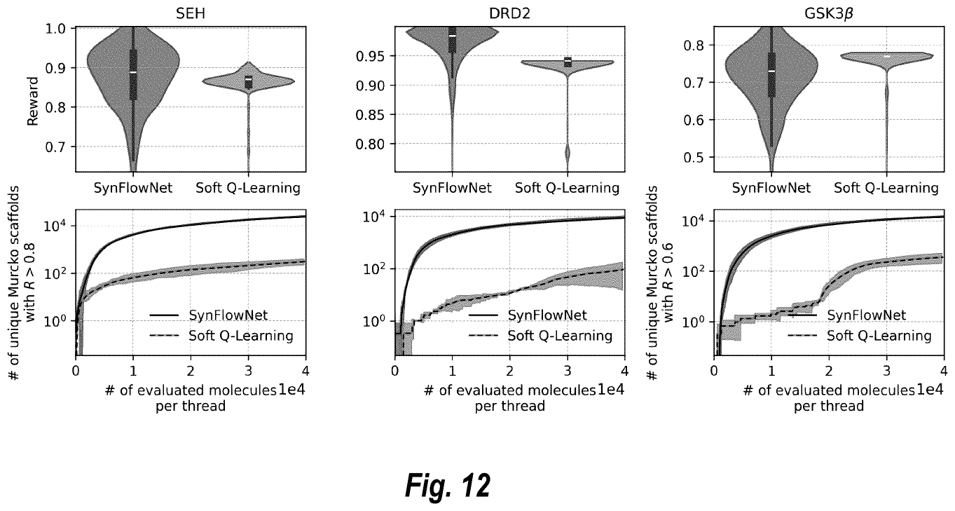

FIG. 12 illustrates a comparison between the training methods of the SynFlowNet system 100 and training methods of existing systems in accordance with one or more embodiments. For example, the top row in FIG. 12 shows reward based on sEH, DRD2, and GSK3β. Specifically, the top row in FIG. 12 shows that the SynFlowNet system 100 outperforms existing systems that use soft Q-learning. Further, the bottom row in FIG. 12 shows the number of unique Murcko scaffolds (e.g., sampled diversity) of the SynFlowNet system 100 (e.g., indicated in the graph with a solid line) compared with existing systems that use soft Q-learning (e.g., indicated in the graph with the dotted line). As shown in the bottom row, the SynFlowNet system 100 significantly outperforms existing systems.

In one or more embodiments, existing systems use soft Q-learning training which is an energy-based policy learning method. For example, soft Q-learning includes performing both manual and grid searches across several values of entropy regularization parameter (alpha) and reward scaling parameter (beta). Specifically, soft Q-learning involves estimating Q-values of each actions directly. To illustrate, existing systems use soft Q-learning as described in Tuomas Haarnoja, Haoran Tang, Pieter Abbeel, and Sergey Levine, Reinforcement learning with deep energy-based policies, 2017.

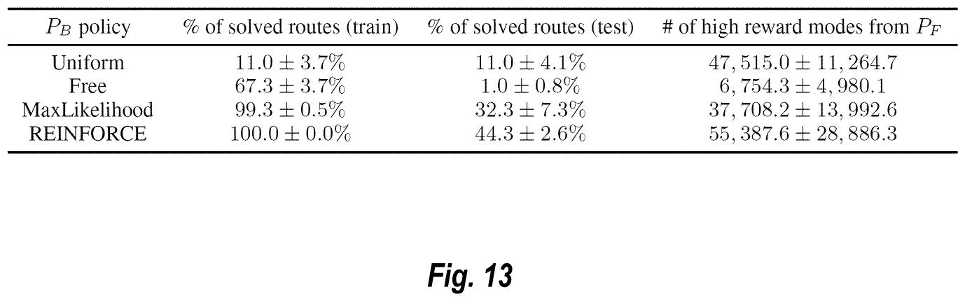

FIG. 13 illustrates an example table of a comparison of the training schemes of the SynFlowNet system 100 compared with existing methods in accordance with one or more embodiments. For example, FIG. 13 shows experimenters evaluating the effectiveness of training schemes of the SynFlowNet system 100 for the chemically constrained backward policy network. Specifically, experimenters measure whether the training schemes used by the SynFlowNet system 100 for the chemically constrained backward policy network can generate backward-constructed trajectories that reliably find a trajectory back to an initial viable chemical state (e.g., generated by the forward policy) and whether the backward policy training scheme brings any benefit to the chemically constrained forward policy network.

FIG. 13 illustrates a comparison of a fixed uniform backward policy to three versions of a parameterized backward policy. Specifically, FIG. 13 shows experimenters comparing the uniform backward policy with a free policy (updated with respect to a trajectory balance loss), a policy trained with the maximum likelihood objective on the forward generated trajectories (as discussed above in FIG. 8), and a policy that is allowed to explore the backward action space and is trained with REINFORCE to find paths leading back to initial viable chemical states (as discussed in FIG. 9).

For instance, FIG. 13 shows that for both the maximum likelihood objective and reinforcement learning, the chemically constrained backward policy network succeeds in generating/modeling backward flow that is not lost outside of the Markov decision process. Specifically, these training methods manage to construct trajectories that start from terminal states sampled from the forward policy network all the way to the initial viable chemical states. The table in FIG. 13 refers to such routes as solved routes (train) in the table.

As the terminal states have been visited by the generative flow network during training, experimenters also test the ability of the trained policies to retrieve synthesis routes for molecules which have not been visited during training, indicated as solved routes (test) in the table. These were obtained from a random sampler using a set of reaction templates and molecular building blocks. While FIG. 13 shows small differences in the number of high-reward modes discovered for different backward policies, FIG. 13 also shows that a free policy consistently fails to be competitive with the rest of the policies. Overall, the maximum likelihood objective (e.g., discussed in FIG. 8) and reinforce policies (e.g., discussed in FIG. 9) proves effective in guiding the chemically constrained forward policy network to high reward modes, while providing consistency in the Markov decision process.

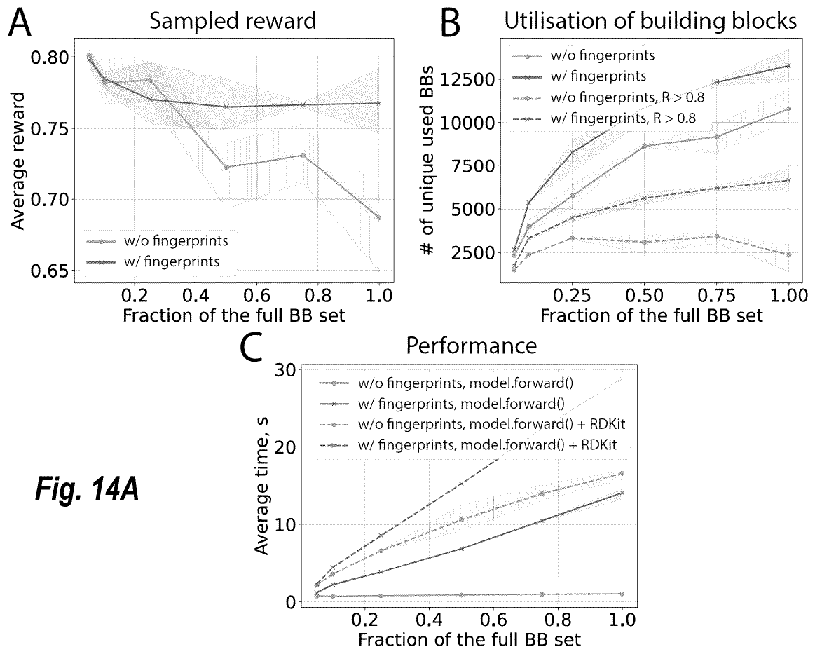

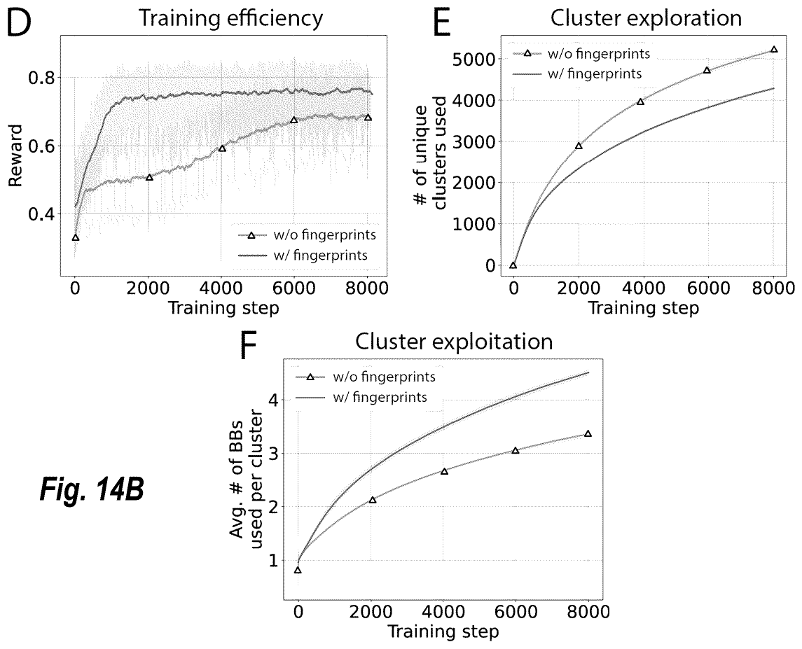

FIGS. 14A-14B illustrates experimenters comparing the average reward, diversity and performance for models that use binary Morgan fingerprints to represent molecular building blocks and for models that do not use binary Morgan fingerprints in accordance with one or more embodiments. Specifically, experimenters determined that vector representations and the binary Morgan fingerprints enable more efficient learning, to help an agent (the chemically constrained forward policy network) to navigate a set of available building blocks and tends to exploit more relevant molecular building block clusters.

Generally, increasing the number of molecular building blocks negatively affects the quality of the sampled molecules (e.g., in terms of reward). However, as shown in FIG. 14A (the graph on the top left), experimenters found that the SynFlowNet system 100 that uses a model with binary Morgan fingerprints outperformed models that do not use binary Morgan fingerprints, despite the increase in the number of molecular building blocks (e.g., relative to existing baselines). The graph on the top left in FIG. 14A shows that the average reward for models that use binary Morgan fingerprints is higher than models that do not use Morgan fingerprints. As illustrated, the higher reward is especially prominent for models that use Morgan fingerprints as the fraction of the full building block set increases. Thus, the SynFlowNet system 100 using binary Morgan fingerprints makes the reward degradation effect essentially negligible.

Furthermore, as illustrated in the top right graph in FIG. 14A, experimenters found that the SynFlowNet system 100 that uses binary Morgan fingerprints consistently uses more unique molecular building blocks than a baseline model (that does not use Morgan fingerprints). Notably, the baseline model, is only able to use a small subset of building blocks to produce high-quality samples. In contrast, the SynFlowNet system 100 using the Morgan fingerprints enables the use of a five-fold larger set of molecular blocks for the same level of quality, thus significantly surpassing the baseline samples in terms of diversity. Additionally, as illustrated in the bottom middle graph in FIG. 14A, experimenters found that models with Morgan fingerprints and vector representations (e.g., indicated as RDKit in the right graph) outperformed other models without Morgan fingerprints and without vector representations.

Moreover, the top left graph in FIG. 14B illustrates that the SynFlowNet system 100 using Morgan fingerprints enables more efficient learning (e.g., for the chemically constrained forward policy network) on a large building block set. Specifically, the top left graph in FIG. 14B shows that models with Morgan fingerprints (e.g., indicated in the graph by the solid line, whereas the graph shows models without Morgan fingerprints as the line with triangles) exploit higher rewards over a fewer number of training steps. Rather than memorizing all available molecular building blocks, the SynFlowNet system 100 uses the chemically constrained forward policy network to navigate in the embedding space and maximizes the dot product with relevant molecular building blocks. Specifically, the SynFlowNet system 100 clusters all available molecular building blocks based on a Tanimoto similarity.

Furthermore, the top right graph and the bottom middle graph in FIG. 14B illustrates that experimenters have found that the SynFlowNet system 100 that uses Morgan fingerprints (e.g., indicated in the graph by the solid line, whereas the graph shows modles without Morgan fingerprints as the line with triangles) with clustering focuses on molecular building block clusters that maximize reward (e.g., rather than exploring a wide range of clusters and less unique molecular building blocks within each cluster).

Herein, additional details related to curating a library (e.g. curating a dataset as described above in FIG. 2) for a chemical-reaction space library is provided. For instance, the above discussion distinguishes between a fragment-based action space and a chemical-reaction action space. The details provided herein provide some more context for that differentiation.

For example, fragment-based drug discovery simplifies the search space by focusing on smaller molecular fragments, rather than designing or screening full molecules, enabling a more efficient exploration of potential binding interactions. For instance, to identify molecules bound within the same pocket across different structures, the SynFlowNet system 100 performs a sequence-based search using MMSeqs2 across a protein data bank as described in Martin Steinegger and Johnnes Soding, Mmseqs2 enables sensitive protein sequence searching for the analysis of massive data sets, Nature biotechnology, 35(11):1026-1028, 2017.

Further, the SynFlowNet system 100 only retains hits with a sequence identity of 90% or greater and an alignment overlap exceeding 80% to provide high similarity to the reference target. Specifically, the resulting protein data bank structures were structurally aligned according to ligand-bound chain with the reference structure, and any ligand with at least one atom within 2 Angstrom of the reference ligand in the binding site. For instance, small molecular fragments (e.g., suitable for fragment-based drug discovery) includes ligands containing more than 25 atoms, as this atom count aligns with typical building block molecule sizes. In other words, the fragment-based space (e.g., existing systems) can be defined as ligands with less than 25 atoms, while the molecular building blocks in the chemical-reaction action space (e.g., the action space of the SynFlowNet system 100) can be defined as ligands with more than 25 atoms in one or more embodiments.

To reiterate, the SynFlowNet system 100 samples from a chemical-reaction action space which avoids sampling from potentially unrealistic fragments, and further improves the diversity, reward, and synthesizability of molecular structures relative to existing systems.

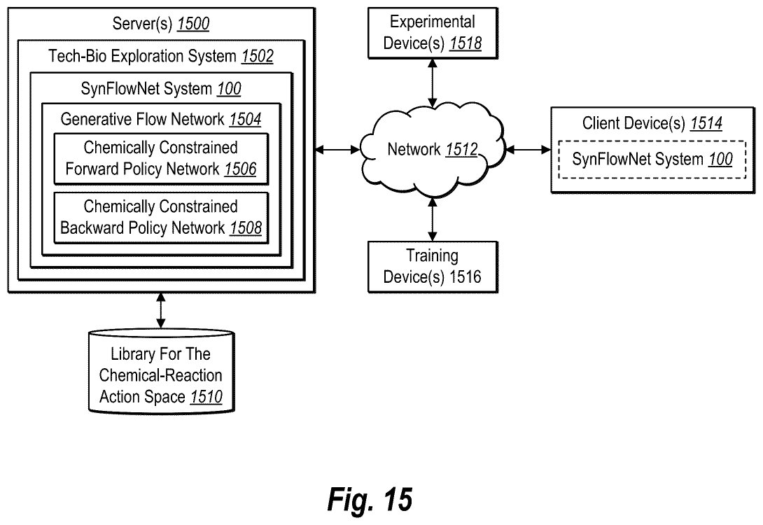

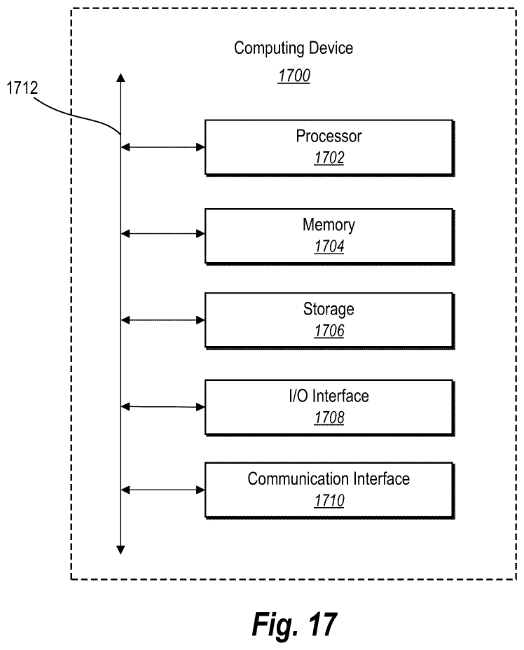

As shown in FIG. 15, the environment includes server(s) 1500 (which includes a tech-bio exploration system 1502 and the SynFlowNet system 100), a network 1512, and client device(s) 1514. As further illustrated in FIG. 15, the various computing devices within the environment can communicate via the network 1512. Although FIG. 15 illustrates the SynFlowNet system 100 being implemented by a particular component and/or device within the environment, the SynFlowNet system 100 can be implemented, in whole or in part, by other computing devices and/or components in the environment (e.g., the additional device(s)). Additional description regarding the illustrated computing devices is provided with respect to FIG. 17 below.

As shown in FIG. 15, the server(s) 1500 (e.g., one or more local servers operated by a particular entity) can include the tech-bio exploration system 1502. In some embodiments, the tech-bio exploration system 1502 can determine, store, generate, and/or display tech-bio information including maps of biology, experiments from various sources, and/or machine learning tech-bio predictions. For instance, the tech-bio exploration system 1502 can analyze data signals corresponding to various treatments or interventions (e.g., compounds or biologics) and the corresponding relationships in genetics, proteomics, phenomics (i.e., cellular phenotypes), and invivomics (e.g., expressions or results within a living animal). Moreover, the tech-bio exploration system 1502 provides an environment for operating, executing, and managing complex drug discovery pipelines.

For instance, the tech-bio exploration system 1502 can generate and access experimental results corresponding to gene sequences, protein shapes/folding, protein/compound interactions, phenotypes resulting from various interventions or perturbations (e.g., gene knockout sequences or compound treatments), and/or invivo experimentation on various treatments in living animals. By analyzing these signals (e.g., utilizing various machine learning models), the tech-bio exploration system 1502 can generate or determine a variety of predictions and inter-relationships for improving treatments/interventions.

To illustrate, the tech-bio exploration system 1502 can generate maps of biology indicating biological inter-relationships or similarities between these various input signals to discover potential new treatments as part of the complex compound discovery process. For example, the tech-bio exploration system 1502 can utilize machine learning and/or maps of biology to identify a similarity between a first gene associated with disease treatment and a second gene previously unassociated with the disease based on a similarity in resulting phenotypes from gene knockout experiments. The tech-bio exploration system 1502 can then identify new treatments based on the gene similarity (e.g., by targeting compounds the impact the second gene). Similarly, the tech-bio exploration system 1502 can analyze signals from a variety of sources (e.g., protein interactions, or invivo experiments) to predict efficacious treatments based on various levels of biological data.

The tech-bio exploration system 1502 can generate GUIs comprising dynamic user interface elements to convey tech-bio information and receive user input for intelligently exploring tech-bio information. Indeed, as mentioned above, the tech-bio exploration system 1502 can generate GUIs displaying different maps of biology that intuitively and efficiently express complex interactions between different biological systems for identifying improved treatment solutions. Furthermore, the tech-bio exploration system 1502 can also electronically communicate tech-bio information between various computing devices.

As shown in FIG. 15, the tech-bio exploration system 1502 can include a system that facilitates various models or algorithms for generating maps of biology (e.g., maps or visualizations illustrating similarities or relationships between genes, proteins, diseases, compounds, and/or treatments) and discovering new treatment options over one or more networks. For example, the tech-bio exploration system 1502 collects, manages, and transmits data across a variety of different entities, accounts, and devices. In some cases, the tech-bio exploration system 1502 is a network system that facilitates access to (and analysis of) tech-bio information within a centralized operating system. Indeed, the tech-bio exploration system 1502 can link data from different network-based research institutions to generate and analyze maps of biology.

As shown in FIG. 15, the tech-bio exploration system 1502 can include a system that comprises the SynFlowNet system 100 that generates, stores, manages, transmits data pertaining to molecular structures built from a library 1510 for the chemical-reaction action space. Specifically, FIG. 15 shows the SynFlowNet system 100 further includes a generative flow network 1504 that includes a chemically constrained forward policy network 1506 and a chemically constrained backward policy network 1508. For example, in context of the above description for the tech-bio exploration system 1502, in some embodiments the tech-bio exploration system 1502 further utilizes the SynFlowNet system 100 to enhance the coordination between various groups involved in the drug discovery process. For instance, the SynFlowNet system 100 works in tandem with the tech-bio exploration system 1502 to generate molecular structures that indicate similarities or relationships between genes, proteins, diseases, compounds, and/or treatments) and can utilize generated molecular structures to further discover new treatment options. Specifically, the tech-bio exploration system 1502 utilizes the SynFlowNet system 100 to generate variations of different molecular structures based on different drug exploration objectives (e.g., generate a biochemical structure with a high binding affinity with a specific type of protein).

To illustrate, the SynFlowNet system 100 utilizes the generative flow network 1504 to sample molecular building blocks and/or chemical reactions from the library 1510 for the chemical-reaction action space. Specifically, the SynFlowNet system 100 determines to select one or more molecular building blocks and/or chemical reactions based on the current chemical state. As mentioned above, the SynFlowNet system 100 generates action prediction scores for molecule generation actions. To further illustrate, the tech-bio exploration system 1502 utilizes the SynFlowNet system 100 at the program discovery phase to identify compounds (e.g., molecular structures) that target certain genes. For instance, the SynFlowNet system 100 can test various hypotheses for how a gene is affected by a compound and utilizes the generative flow network 1504 to explore a large state space to efficiently learn active learning targets. Moreover, in some embodiments, the tech-bio exploration system 1502 utilizes the SynFlowNet system 100 at the hit-to-lead phase (e.g., where a set of feasible compounds have already been identified) and performs additional iterations of the feasible compounds to refine the set of feasible compounds (e.g., narrow down the list by exploring the state space and prioritizing greedier actions, e.g., higher reward actions).

As also illustrated in FIG. 15, the environment includes the client device(s) 1514. As mentioned above, the client device(s) 1514 can be involved in the process of drug discovery. Thus, for example, the client device(s) 1514 can coordinate/manage generating a particular molecular structure along with additional mode variations of the molecular structure for further downstream testing. For instance, the client device(s) 1514 can coordinate/manage testing generated molecular structures under various conditions to further determine whether to initiate one or more programs (industrial program generation or industrial compound generation) for one or more of the generated molecular structures.

To illustrate, the client device(s) 1514 can include computing devices that implement or manage a compound program generation stage of a compound discovery process. Similarly, the client device(s) 1514 can include computing devices that implement or manage a compound lead generation stage and the client device(s) 1514 can include computing devices that implement or manage a compound/dose selection stage. For example, the SynFlowNet system 100 can receive one or more requests to generate one or more molecular structures according to an input state and an objective for that input state.

In some embodiments, the environment also includes additional device(s). For example, the SynFlowNet system 100 can utilize the additional device(s) to further operate and manage downstream operations after generating one or more molecular structures. For instance, the additional device(s) include experimental device(s) and analytical device(s). Further, in some instances, the additional device(s) also include the computing devices discussed below in FIG. 17.

Furthermore, in one or more implementations, the client device(s) 1514 include a client application. The client application can include instructions that (upon execution) cause the client device(s) 1514 to perform various actions. For example, a user of a user account can interact with the client application on the client device(s) 1514 to execute the generation of molecular structures (e.g., or other non-biochemical structures) by exploring a state space and executing experiments or other multi-faceted based on generated molecular structures. For instance, in some embodiments the SynFlowNet system 100 receives a request to generate a molecular structure from an input state and an objective for the input state. In response, the SynFlowNet system 100 can further generate one or more molecular structures according to the objective and returns the molecular structure to the client device(s) 1514. In some instances, the transmittal of the molecular structure to the client device(s) 1514 causes the client device(s) 1514 to further present options for executing an action (e.g., performing downstream experiments, tests, or evaluations of the generated molecular structure).

In one or more embodiments, the environment can also include dedicated training device(s) 1516. For example, the dedicated training device(s) 1516 can include computing devices or virtual machines dedicated to training or implementing the generative flow network 1504. For example, the dedicated training device(s) 1516 can provide datasets, parameters, objectives, and other learning constraints to train the generative flow network 1504 to generate outputs specific to a task (e.g., RNA generation, small molecule generation, etc.). Thus, the SynFlowNet system 100 interacts with the dedicated training device(s) 1516 to learn certain state spaces and to accurately generate corresponding flow-measures.

The environment can also include experimental device(s) 1518. For example, the tech-bio exploration system 1502 can interact with the experimental device(s) 1518 that include intelligent robotic devices and camera devices for generating and capturing digital images of cellular phenotypes resulting from different perturbations (e.g., genetic knockouts or compound treatments of stem cells). Similarly, the experimental device(s) can include camera devices and/or other sensors (e.g., heat or motion sensors) capturing real-time information from animals as part of invivo experimentation. The tech-bio exploration system 1502 can also interact with a variety of other experimental device(s) such as devices for determining, generating, or extracting gene sequences or protein information. For example, the experimental device(s) 1518 may include computing devices linked to biosensorselectrophysiological platforms, x-ray crystallography machines, liquid chromatography mass spectrometry systems, nuclear magnetic resonance spectrometers, mass spectrometers. In some implementations, the SynFlowNet system 100 generates tractability scores and further determines to employ or utilize one or more experimental devices (e.g., to initiate one or more experiments based on the tractability scores).

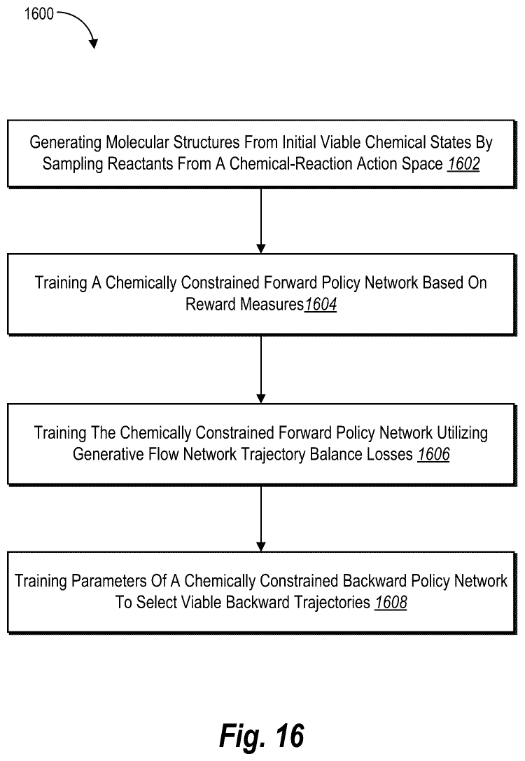

As further shown in FIG. 15, the environment includes the network 1512. As mentioned above, the network 1512 can enable communication between components of the environment. In one or more embodiments, the network 1512 may include a suitable network and may communicate using a various number of communication platforms and technologies suitable for transmitting data and/or communication signals, examples of which are described with reference to FIG. 16. Furthermore, although FIG. 14 illustrates computing devices communicating via the network 1512, the various components of the environment can communicate and/or interact via other methods (e.g., communicate directly).

FIGS. 1-15, the corresponding text, and the examples provide a number of different systems, methods, and non-transitory computer readable media for utilizing a generative flow networks to generate a molecular structure. In addition to the foregoing, embodiments can also be described in terms of flowcharts comprising acts for accomplishing a particular result. For example, FIG. 16 illustrates a flowchart of an example sequence of acts in accordance with one or more embodiments.

While FIG. 16 illustrates acts according to some embodiments, alternative embodiments may omit, add to, reorder, and/or modify any of the acts shown in FIG. 16. The acts of FIG. 16 can be performed as part of a method (e.g., a computer-implemented method). Alternatively, a non-transitory computer readable medium can comprise instructions, that when executed by one or more processors (e.g., at least one processor), cause a computing device to perform the acts of FIG. 16. In still further embodiments, a system can perform the acts of FIG. 16. Additionally, the acts described herein may be repeated or performed in parallel with one another or in parallel with different instances of the same or other similar acts.

FIG. 16 illustrates an example series of acts 1600 for training parameters of a chemically constrained forward policy network and a chemically constrained backward policy network in accordance with one or more embodiments. The series of acts 1600 can include an act 1602 of generating molecular structures from initial viable chemical states by sampling reactants from a chemical-reaction action space, an act 1604 of training a chemically constrained forward policy network based on reward measures, an act 1606 of training the chemically constrained forward policy network utilizing generative flow network trajectory balance losses, and an act 1608 of training parameters of a chemically constrained backward policy network to select viable backward trajectories.

Specifically, the series of acts 1600 can include acts 102-1608 of generating, utilizing a chemically constrained forward policy network of a generative flow network, molecular structures from initial viable chemical states by sampling reactants from a chemical-reaction action space; training the chemically constrained forward policy network based on reward measures corresponding to the molecular structures; training the chemically constrained forward policy network utilizing generative flow network trajectory balance losses based on comparing the chemically constrained forward policy network and a chemically constrained backward policy network of the generative flow network; and training parameters of the chemically constrained backward policy network to select viable backward trajectories corresponding to the molecular structures, wherein the viable backward trajectories lead to the initial viable chemical states.

For example, in one or more embodiments, the series of acts 1600 includes sampling from a library of existing molecular building blocks and chemical reactions. In one or more implementations, the series of acts 1600 includes generating, utilizing a graph transformer, a vector representation from the additional chemical state; and generating, utilizing a plurality of neural networks from the vector representation, action prediction scores for molecule generation actions.

In addition, in one or more implementations, the series of acts 1600 includes generating the action prediction scores for the molecule generation actions comprises generating a first action prediction score for a uni-molecular reaction; generating a second action prediction score for a bi-molecular reaction; and generating a third action prediction score for a stop action.

Further, in some implementations, the series of acts 1600 includes generating a molecular structure from the additional chemical state by comparing the action prediction scores to select a molecule generation action from the molecule generation actions; and executing the selected molecule generation action to generate the molecular structure from the additional chemical state.

In one or more implementations, the series of acts 1600 includes identifying one or more molecular-reaction incompatibilities based on the additional chemical state, molecular building blocks, and chemical reactions; and selecting the molecular building block by masking a subset of the molecular building blocks and a subset of the chemical reactions based on the one or more molecular-reaction incompatibilities. Moreover, in one or more implementations, the series of acts 1600 includes generating a reward measure for a molecular structure of the molecular structures, wherein the reward measure indicates binding energy between the molecular structure and a protein target; and modifying parameters of the chemically constrained forward policy network based on the reward measure.

In addition, in some implementations, the series of acts 1600 includes generating the generative flow network trajectory balance losses by comparing a forward measure of probability flow between states for the chemically constrained forward policy network and a backward measure of probability flow between states for the chemically constrained backward policy network.

In one or more implementations, the series of acts 1600 includes excluding non-viable backward trajectories by utilizing a maximum-likelihood objective over trajectories sampled from the chemically constrained forward policy network. Moreover, in one or more implementations, the series of acts 1600 includes generating, utilizing the chemically constrained backward policy network, one or more backward trajectories from an additional chemical state to an initial chemical state; determining a backward measure of reward by comparing the initial chemical state to the initial viable chemical states; and training parameters of the chemically constrained backward policy network based on the backward measure of reward.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 17 illustrates a block diagram of an example computing device 1700 that may be configured to perform one or more of the processes described above. One will appreciate that one or more computing devices, such as the computing device 1700 may represent the computing devices described above. In one or more embodiments, the computing device 1700 may be a mobile device (e.g., a mobile telephone, a smartphone, a PDA, a tablet, a laptop, a camera, a tracker, a watch, a wearable device, etc.). In some embodiments, the computing device 1700 may be a non-mobile device (e.g., a desktop computer or another type of client device). Further, the computing device 1700 may be a server device that includes cloud-based processing and storage capabilities.

As shown in FIG. 17, the computing device 1700 can include one or more processor(s) 1702, memory 1704, a storage device 1706, input/output interfaces 1708 (or “I/O interfaces 1708”), and a communication interface 1710, which may be communicatively coupled by way of a communication infrastructure (e.g., bus 1712). While the computing device 1700 is shown in FIG. 17, the components illustrated in FIG. 17 are not intended to be limiting. Additional or alternative components may be used in other embodiments. Furthermore, in certain embodiments, the computing device 1700 includes fewer components than those shown in FIG. 17. Components of the computing device 1700 shown in FIG. 17 will now be described in additional detail.

In particular embodiments, the processor(s) 1702 includes hardware for executing instructions, such as those making up a computer program. As an example, and not by way of limitation, to execute instructions, the processor(s) 1702 may retrieve (or fetch) the instructions from an internal register, an internal cache, memory 1704, or a storage device 1706 and decode and execute them.

The computing device 1700 includes memory 1704, which is coupled to the processor(s) 1702. The memory 1704 may be used for storing data, metadata, and programs for execution by the processor(s). The memory 1704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1704 may be internal or distributed memory.

The computing device 1700 includes a storage device 1706 includes storage for storing data or instructions. As an example, and not by way of limitation, the storage device 1706 can include a non-transitory storage medium described above. The storage device 1706 may include a hard disk drive (HDD), flash memory, a Universal Serial Bus (USB) drive or a combination these or other storage devices.

As shown, the computing device 1700 includes one or more I/O interfaces 1708, which are provided to allow a user to provide input to (such as user strokes), receive output from, and otherwise transfer data to and from the computing device 1700. These I/O interfaces 1708 may include a mouse, keypad or a keyboard, a touch screen, camera, optical scanner, network interface, modem, other known I/O devices or a combination of such I/O interfaces 1708. The touch screen may be activated with a stylus or a finger.

The I/O interfaces 1708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1708 are configured to provide graphical data to a display for presentation to a user. The graphical data may be representative of one or more graphical user interfaces and/or any other graphical content as may serve a particular implementation.

The computing device 1700 can further include a communication interface 1710. The communication interface 1710 can include hardware, software, or both. The communication interface 1710 provides one or more interfaces for communication (such as, for example, packet-based communication) between the computing device and one or more other computing devices or one or more networks. As an example, and not by way of limitation, communication interface 1710 may include a network interface controller (NIC) or network adapter for communicating with an Ethernet or other wire-based network or a wireless NIC (WNIC) or wireless adapter for communicating with a wireless network, such as a WI-FI. The computing device 1700 can further include a bus 1712. The bus 1712 can include hardware, software, or both that connects components of computing device 1700 to each other.

In one or more implementations, various computing devices can communicate over a computer network. This disclosure contemplates any suitable network. As an example, and not by way of limitation, one or more portions of a network may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these.

In particular embodiments, the computing device 1700 can include a client device that includes a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device one or more Hyper Text Markup Language (“HTML”) files responsive to the HTTP request. The client device may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the tech-bio exploration system 1502 may include a variety of servers, sub-systems, programs, modules, logs, and data stores. In particular embodiments, the tech-bio exploration system 1502 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The tech-bio exploration system 1502 may also include suitable components such as network interfaces, security mechanisms, load balancers, failover servers, management-and-network-operations consoles, other suitable components, or any suitable combination thereof. In particular embodiments, the tech-bio exploration system 1502 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the tech-bio exploration system 1502 and one or more client devices. An action logger may be used to receive communications from a web server about a user's actions on or off the tech-bio exploration system 1502. In conjunction with the action log, a third-party-content-object log may be maintained of user exposures to third-party-content objects. A notification controller may provide information regarding content objects to a client device. Information may be pushed to a client device as notifications, or information may be pulled from a client device responsive to a request received from the client device. Authorization servers may be used to enforce one or more privacy settings of the users of the tech-bio exploration system 1502. A privacy setting of a user determines how particular information associated with a user can be shared. The authorization server may allow users to opt in to or opt out of having their actions logged by the tech-bio exploration system 1502 or shared with other systems, such as, for example, by setting appropriate privacy settings. Third-party-content-object stores may be used to store content objects received from third parties. Location stores may be used for storing location information received from a client device associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a chemically constrained forward policy network of a generative flow network, molecular structures from initial viable chemical states by sampling reactants from a chemical-reaction action space;
training the chemically constrained forward policy network based on reward measures corresponding to the molecular structures;
training the chemically constrained forward policy network utilizing generative flow network trajectory balance losses based on comparing the chemically constrained forward policy network and a chemically constrained backward policy network of the generative flow network; and
training parameters of the chemically constrained backward policy network to select viable backward trajectories corresponding to the molecular structures, wherein the viable backward trajectories lead to the initial viable chemical states.

2. The computer-implemented method of claim 1, wherein sampling from the chemical-reaction action space comprises sampling from a library of existing molecular building blocks and chemical reactions.

3. The computer-implemented method of claim 1, wherein generating the molecular structures comprises, for an additional chemical state:
generating, utilizing a graph transformer, a vector representation from the additional chemical state; and
generating, utilizing a plurality of neural networks from the vector representation, action prediction scores for molecule generation actions.

4. The computer-implemented method of claim 3, wherein generating the action prediction scores for the molecule generation actions comprises:
generating a first action prediction score for a uni-molecular reaction;
generating a second action prediction score for a bi-molecular reaction; and
generating a third action prediction score for a stop action.

5. The computer-implemented method of claim 3, further comprising generating a molecular structure from the additional chemical state by:
comparing the action prediction scores to select a molecule generation action from the molecule generation actions; and
executing the selected molecule generation action to generate the molecular structure from the additional chemical state.

6. The computer-implemented method of claim 5, wherein the molecule generation action comprises adding a molecular building block and selecting the molecule generation action comprises:
identifying one or more molecular-reaction incompatibilities based on the additional chemical state, molecular building blocks, and chemical reactions; and
selecting the molecular building block by masking a subset of the molecular building blocks and a subset of the chemical reactions based on the one or more molecular-reaction incompatibilities.

7. The computer-implemented method of claim 1, wherein training the chemically constrained forward policy network comprises:
generating a reward measure for a molecular structure of the molecular structures, wherein the reward measure indicates binding energy between the molecular structure and a protein target; and
modifying parameters of the chemically constrained forward policy network based on the reward measure.

8. The computer-implemented method of claim 1, wherein training the chemically constrained forward policy network utilizing the generative flow network trajectory balance losses comprises generating the generative flow network trajectory balance losses by comparing a forward measure of probability flow between states for the chemically constrained forward policy network and a backward measure of probability flow between states for the chemically constrained backward policy network.

9. The computer-implemented method of claim 1, wherein training the parameters of the chemically constrained backward policy network comprises excluding non-viable backward trajectories by utilizing a maximum-likelihood objective over trajectories sampled from the chemically constrained forward policy network.

10. The computer-implemented method of claim 1, wherein training the parameters of the chemically constrained backward policy network utilizing reinforcement learning by:
generating, utilizing the chemically constrained backward policy network, one or more backward trajectories from an additional chemical state to an initial chemical state;
determining a backward measure of reward by comparing the initial chemical state to the initial viable chemical states; and
training parameters of the chemically constrained backward policy network based on the backward measure of reward.

11. A system comprising:
at least one processor; and
at least one non-transitory computer-readable storage medium storing instructions that, when executed by the at least one processor, cause the system to:
generate, utilizing a chemically constrained forward policy network of a generative flow network, molecular structures from initial viable chemical states by sampling reactants from a chemical-reaction action space;
train the chemically constrained forward policy network based on reward measures corresponding to the molecular structures;
train the chemically constrained forward policy network utilizing generative flow network trajectory balance losses based on comparing the chemically constrained forward policy network and a chemically constrained backward policy network of the generative flow network; and
train parameters of the chemically constrained backward policy network to select viable backward trajectories corresponding to the molecular structures, wherein the viable backward trajectories lead to the initial viable chemical states.

12. The system of claim 11, further comprising instructions that, when executed by the at least one processor, cause the system to sample from the chemical-reaction action space by sampling from a library of existing molecular building blocks and chemical reactions.

13. The system of claim 11, further comprising instructions that, when executed by the at least one processor, cause the system to generate the molecular structures for an additional chemical state by:
generating, utilizing a graph transformer, a vector representation from the additional chemical state; and
generating, utilizing a plurality of neural networks from the vector representation, action prediction scores for molecule generation actions.

14. The system of claim 13, further comprising instructions that, when executed by the at least one processor, cause the system to train the chemically constrained forward policy network by:
generating a reward measure for a molecular structure of the molecular structures, wherein the reward measure indicates binding energy between the molecular structure and a protein target; and
modifying parameters of the chemically constrained forward policy network based on the reward measure.

15. The system of claim 11, further comprising instructions that, when executed by the at least one processor, cause the system to train the chemically constrained backward policy network utilizing reinforcement learning by:
generating, utilizing the chemically constrained backward policy network, one or more backward trajectories from an additional chemical state to an initial chemical state;
determining a backward measure of reward by comparing the initial chemical state to the initial viable chemical states; and
training parameters of the chemically constrained backward policy network based on the backward measure of reward.

16. A non-transitory computer-readable medium storing instructions that, when executed by at least one processor, cause a computing device to:
generate, utilizing a chemically constrained forward policy network of a generative flow network, molecular structures from initial viable chemical states by sampling reactants from a chemical-reaction action space;
train the chemically constrained forward policy network based on reward measures corresponding to the molecular structures;
train the chemically constrained forward policy network utilizing generative flow network trajectory balance losses based on comparing the chemically constrained forward policy network and a chemically constrained backward policy network of the generative flow network; and
train parameters of the chemically constrained backward policy network to select viable backward trajectories corresponding to the molecular structures, wherein the viable backward trajectories lead to the initial viable chemical states.

17. The non-transitory computer-readable medium of claim 16, further comprising instructions that, when executed by the at least one processor, cause the computing device to sample from the chemical-reaction action space by sampling from a library of existing molecular building blocks and chemical reactions.

18. The non-transitory computer-readable medium of claim 16, further comprising instructions that, when executed by the at least one processor, cause the computing device to generate the molecular structures for an additional chemical state by:
generating, utilizing a graph transformer, a vector representation from the additional chemical state; and
generating, utilizing a plurality of neural networks from the vector representation, action prediction scores for molecule generation actions.

19. The non-transitory computer-readable medium of claim 18, further comprising instructions that, when executed by the at least one processor, cause the computing device to generate the action prediction scores for the molecule generation actions by:
generating a first action prediction score for a uni-molecular reaction;
generating a second action prediction score for a bi-molecular reaction; and
generating a third action prediction score for a stop action.

20. The non-transitory computer-readable medium of claim 16, further comprising instructions that, when executed by the at least one processor, cause the computing device to train the parameters of the chemically constrained backward policy network by excluding non-viable backward trajectories by utilizing a maximum-likelihood objective over trajectories sampled from the chemically constrained forward policy network.
